(19) United States
(12) Patent Application Publication
(10) Pub. No.: US 2005/0071216 A1
(43) Pub. Date: Mar. 31, 2005

(54) Interactive network guide

(75) Inventors: Mark M. Yoshitake, Seattle, WA (US); Craig J. Kitterman, North Bend, WA (US); Danielle Harder, Seattle, WA (US); James A. Lally, Renton, WA (US)

Correspondence Address: KLARQUIST SPARKMAN LLP, 121 S.W. SALMON STREET, SUITE 1600, PORTLAND, OR, 97204, US

(73) Assignee: Microsoft Corporation

(21) Appl. No.: 10/676,365

(22) Filed: Sep. 30, 2003

(51) Int. Cl. G06F 17/60

(52) U.S. Cl. 705/10; 705/7

(57) ABSTRACT

An interactive network guide acts as a computer-based decision support aid for computer novices to design and build a network, such as for a home or small office environment. The guide presents a sequence of questions to gather input data from a user describing the user's computers and environment. The guide evaluates this input data and presents one or more suitable network topologies, which may include hybrid solutions. The guide then dynamically generates a network diagram, shopping list and setup instructions for the user's selection from the suitable network topologies.

### TECHNICAL FIELD

The invention relates generally to computer-based decision support, and more particularly to computer aids or guides for designing and setting up a network.

### BACKGROUND

The number of households and small offices that own multiple computers is growing, and together with this statistic the potential market for networking equipment or products to interconnect these computers with each other and to the Internet. One obstacle limiting sales into this market is the lack of sufficient knowledge among potential customers to choose among various networking technologies and/or topologies, and effectively design or plan purchases of various networking products suited to the customer's location.

Recently, networking equipment vendors have provided World Wide Web-based tutorials to explain networking technologies and topologies to potential customers. However, such tutorials fail to remove the burden on the potential customer to evaluate which network technologies are appropriate for their individual installation, and to design and plan the necessary networking product purchases.

### SUMMARY

An interactive network guide described herein provides a computer-based aid for interactively guiding users through the steps and decisions to design and build their own networks. The interactive network guide prompts its user to enter various parameters describing the computers that are to be networked, as well as their locations. Based on this input, the interactive network guide uses various heuristics to generate a list (e.g., a shopping list) enumerating the networking products for networking the user's computers.

The interactive network guide includes a business logic engine that evaluates the heuristics for deciding among various available networking technologies or solutions appropriate to network individual computers. The business logic engine provides the core logic of the interactive guide, and can be customized or “branded” by a network equipment vendor to provide a look-and-feel featuring the vendor's brand and to generate network designs (e.g., the component list) using the vendor's networking products.

The interactive network guide prompts the user to enter information as to certain characteristics of the computers and their respective locations that determine the suitability of various networking technologies to connect the respective computers to the network. Based on this information, the interactive network guide provides one or more alternative network designs. As appropriate, these designs can include hybrid solutions using combinations of networking technologies (e.g., Ethernet and wireless, Ethernet and powerline, etc.) in cases where characteristics of the computers or their locations call for use of different networking technologies.

The interactive network guide permits the entry of custom names for the computers and designation of their locations. The interactive network guide is then able to distinguish between the user's various computers and locations in its network design(s), and also provides diagrams, setup instructions and shopping lists utilizing the custom computer names and location designations. The interactive network guide thus proscribes user-specific instructions that make clear how each respective computer is to be networked.

Additional features and advantages of the invention will be made apparent from the following detailed description of embodiments that proceeds with reference to the accompanying drawings.

### BRIEF DESCRIPTION OF THE DRAWINGS

FIG. 1 is a diagram of an internet-connected system in which an interactive network guide is provided as a web service or web application.

FIG. 2 is a block diagram of a structure of the interactive network guide implemented alternatively as a distributable executable software to run directly on a computer, or as a web application run over the system of FIG. 1.

FIG. 3 is a block diagram of a suitable computing environment for running the interactive network guide of FIG. 2.

FIG. 4 is a flow chart of a process performed by the interactive network guide of FIG. 2 to aid its user in designing and setting up a network.

FIG. 5 is a data flow diagram of the interactive network guide of FIG. 2.

FIGS. 6-26 are photographic images of a sequence of screen displays or web pages presented in the web application of the interactive network guide of FIG. 2.

FIG. 27 is a pseudo-code listing of a procedure to decode coded network topology options.

FIG. 28A-H is a flow diagram of a process by the interactive network guide of FIG. 2 to assemble network setup instructions.

### DETAILED DESCRIPTION

The following description is directed to computer aids for designing and setting up a network of computers. The description presents an exemplary application of this technology in an interactive network guide that prompts for and evaluates input data as to various characteristics of a user's computers and locations, and produces one or more alternative network designs with diagrams, product list and setup instructions.

1. Business Logic Component

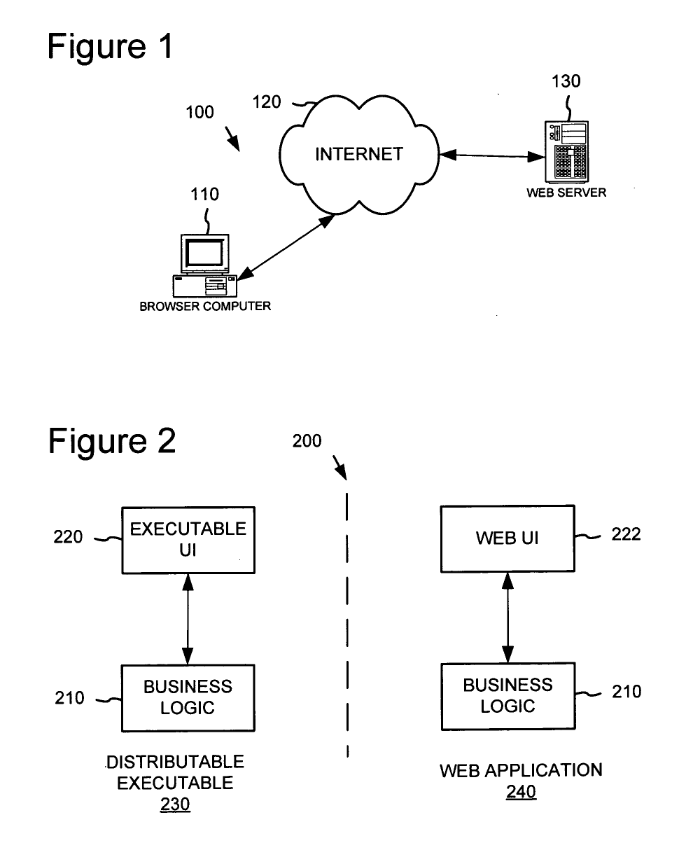

With reference to FIGS. 1 and 2, the illustrated interactive network guide 200 is structured modularly to permit its implementation as a web application 240, or as distributable executable software 230. More specifically, the software of the interactive network guide 200 is structured in two modules or components: a business logic module 210 and a user interface (UI) module 220, 222 of the respective implementation. The business logic module 210 provides the core functionality of the interactive network guide, such as the decision support logic to evaluate suitability of various network designs to the user and generate the network diagrams, product list and setup instructions for the network design. The respective UI module provides the various screen displays and collects input data from the user for the network guide. Although the illustrated interactive network guide is structured as business logic and UI modules, alternative implementations of the interactive network guide can have other structures, e.g., non-modularized or modularized into further of different divisions of its functionality.

In the case of the web application 240, the interactive network guide 200 resides on a web server 130. A user of the interactive network guide 200 operates a web browser application (e.g., Microsoft Internet Explorer) on a browser computer 110 that connects with the web server 130 via the Internet 120. Using the web browser, the user navigates to a web address of the interactive network guide, which may be provided on a web site of a networking products vendor. The various screen displays of the interactive network guide are web pages served from the web server 130 and presented to the user in the web browser on the browser computer 110. The data input by the user in response to these screen displays are communicated back to the interactive network guide software on the web server 130 for processing by the interactive network guide.

In the case of the distributable executable 230, the interactive network guide software is provided as an executable application that may be distributed on recorded data media (e.g., a floppy disk, compact disk (CD), DVD, or like), or via a download or other data transmission to the end user for installation on a computer. In this case, the interactive network guide resides on and runs directly on the end user's computer, which need not be connected to the Internet.

2. Computing Environment

The above described interactive network guide 200 (FIG. 2) can be implemented to run on any of a variety of computing devices and environments, including computers of various form factors (personal, workstation, server, handheld, laptop, tablet, or other mobile), distributed computing networks, and Web services, as a few general examples.

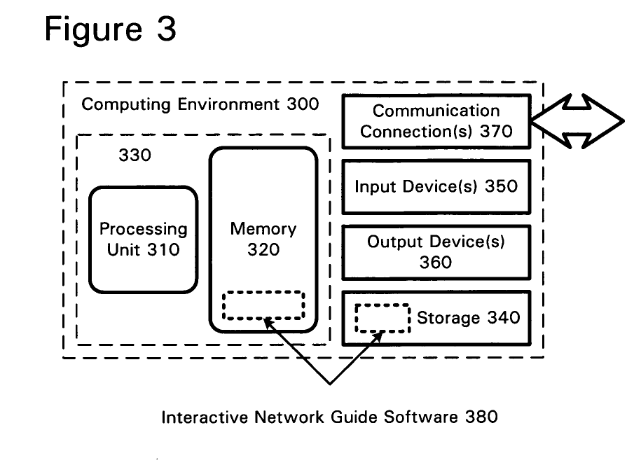

FIG. 3 illustrates a generalized example of a suitable computing environment 300 in which the interactive network guide can be implemented (for example, as the web application or distributable executable). The computing environment 300 is not intended to suggest any limitation as to scope of use or functionality of the invention, as the present invention may be implemented in diverse general-purpose or special-purpose computing environments.

With reference to FIG. 3, the computing environment 300 includes at least one processing unit 310 and memory 320. In FIG. 3, this most basic configuration 330 is included within a dashed line. The processing unit 310 executes computer-executable instructions and may be a real or a virtual processor. In a multi-processing system, multiple processing units execute computer-executable instructions to increase processing power. The memory 320 may be volatile memory (e.g., registers, cache, RAM), non-volatile memory (e.g., ROM, EEPROM, flash memory, etc.), or some combination of the two. The memory 320 stores the interactive network guide software 380.

A computing environment may have additional features. For example, the computing environment 300 includes storage 340, one or more input devices 350, one or more output devices 360, and one or more communication connections 370. An interconnection mechanism (not shown) such as a bus, controller, or network interconnects the components of the computing environment 300. Typically, operating system software (not shown) provides an operating environment for other software executing in the computing environment 300, and coordinates activities of the components of the computing environment 300.

The storage 340 may be removable or non-removable, and includes magnetic disks, magnetic tapes or cassettes, CD-ROMs, CD-RWs, DVDs, or any other medium which can be used to store information and which can be accessed within the computing environment 300. The storage 340 stores instructions for the interactive network guide software 380.

The input device(s) 350 (e.g., for devices operating as a control point in the device connectivity architecture 100) may be a touch input device such as a keyboard, mouse, pen, or trackball, a voice input device, a scanning device, or another device that provides input to the computing environment 300. For audio, the input device(s) 350 may be a sound card or similar device that accepts audio input in analog or digital form, or a CD-ROM reader that provides audio samples to the computing environment. The output device(s) 360 may be a display, printer, speaker, CD-writer, or another device that provides output from the computing environment 300.

The communication connection(s) 370 enable communication over a communication medium to another computing entity. The communication medium conveys information such as computer-executable instructions, audio/video or other media information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

As already mentioned above in the case of the distributable executable implementation for example, the interactive network guide can reside on and be distributed in the form of a computer-readable media. Computer-readable media are any available media that can be accessed within a computing environment. By way of example, and not limitation, with the computing environment 300, computer-readable media include memory 320, storage 340, communication media, and combinations of any of the above.

The techniques herein can be described in the general context of computer-executable instructions, such as those included in program modules, being executed in a computing environment on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing environment.

3. Network Guide Process Flow

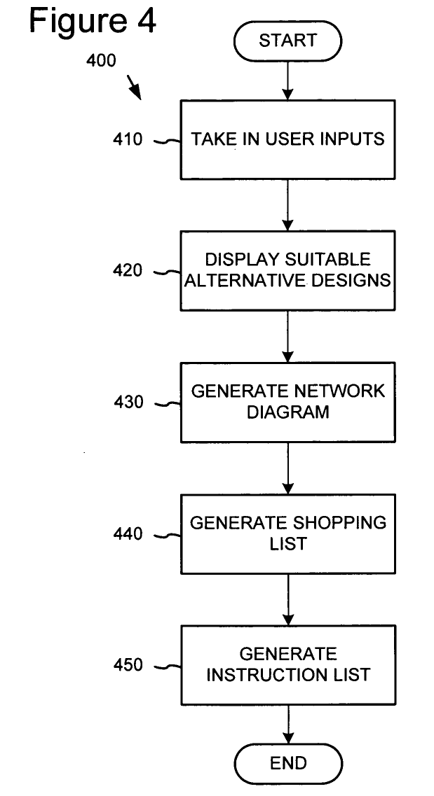

The interactive network guide 200 (FIG. 2) has a general process flow 400 shown in FIG. 4. The interactive network guide begins at 410 with taking in user inputs by asking a series of questions to the user about the characteristics of the computers they own, their usage scenarios, desired physical location of computers, availability of network capable outlets (i.e. phone jacks and power outlets), propensity towards a dedicated router, etc.

The interactive network guide evaluates these user inputs and displays options for various network topologies that are suitable for the user's situation at 420. Based upon the user's selection from the displayed options, the interactive network guide generates a network diagram at 430, generates a shopping list of networking products for the selected network option at 440, and generates an instruction list for setup of the selected network option at 450. The interactive network guide dynamically draws a personalized recommended Network Diagram based on the answers that are given. The interactive network guide presents a recommended Shopping List with recommended technical features for each networking hardware component and a list of devices they already have. These are all mapped to the diagram. The interactive network guide further presents Step by Step Instructions on how to physically connect/install the network once they have purchased the necessary hardware components, and then instructs them how to configure their network settings so that their computers are all in the same workgroup, share printers/internet/files, running the firewall, etc.

In addition to this process flow, the interactive network guide provides additional descriptive or help information to educate the user about the pros and cons of certain networking technology components on a need to know basis as they answer questions (i.e. dedicated router at edge vs. PC at edge, or PhoneLine networking vs. Wireless) The interactive network guide also includes links to Frequently Asked Questions, such as Common tasks associated with the most common network setup issues (i.e. setting up WEP on wireless clients and AP) and most common network enabled scenarios (i.e. transferring a file to another PC, remote desktop). When the user clicks on a task, they are guided through step by step instructions to get what they want, such as how to set up WEP on the client.

4. Interactive Network Guide Architecture Overview

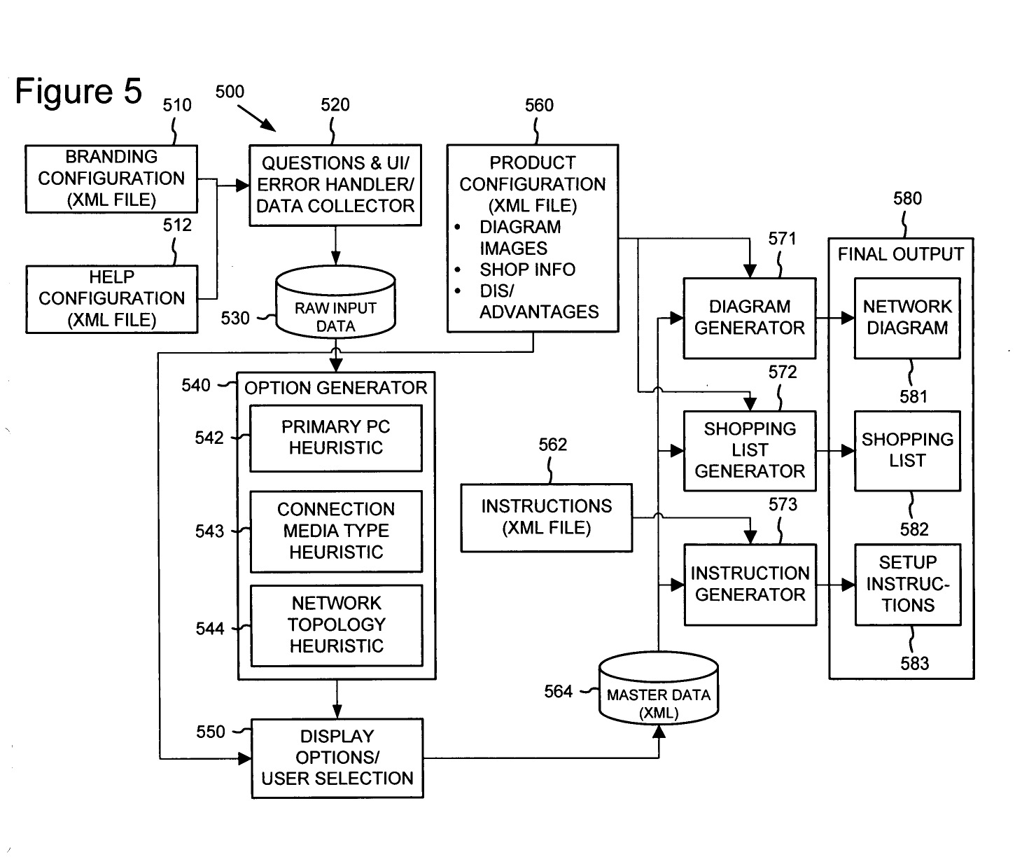

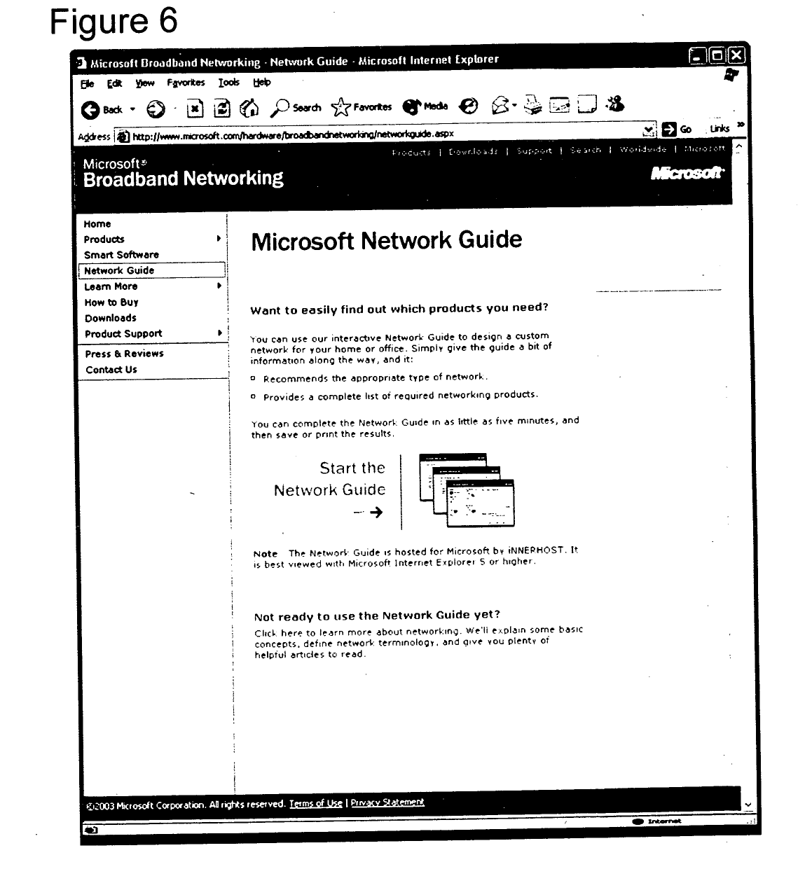

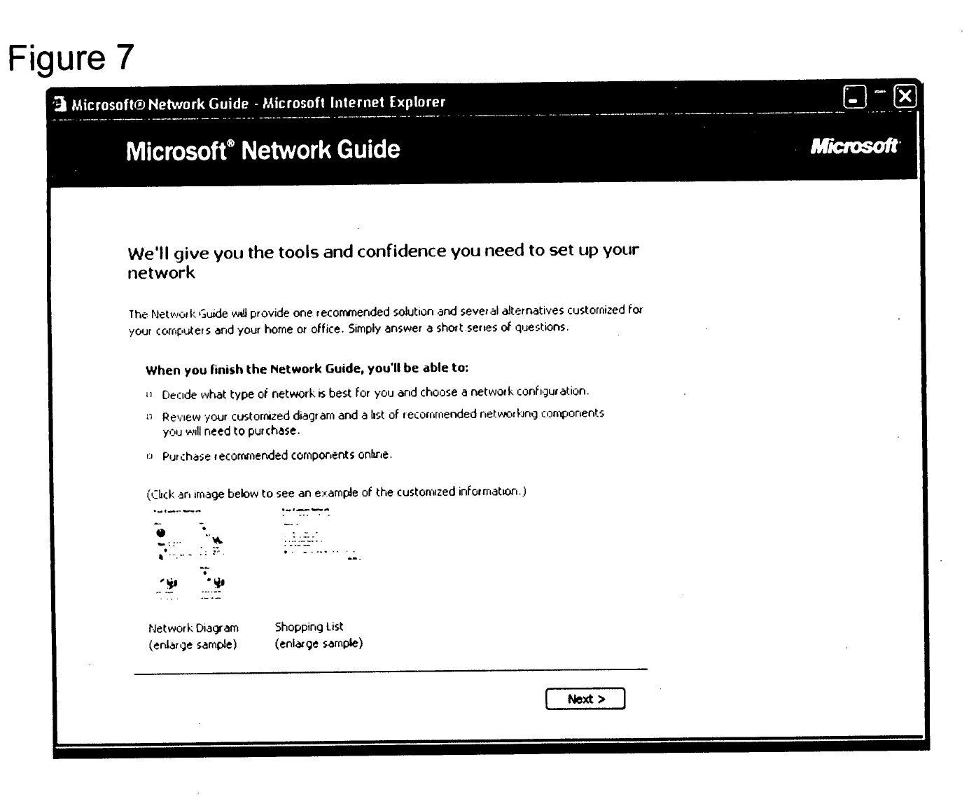

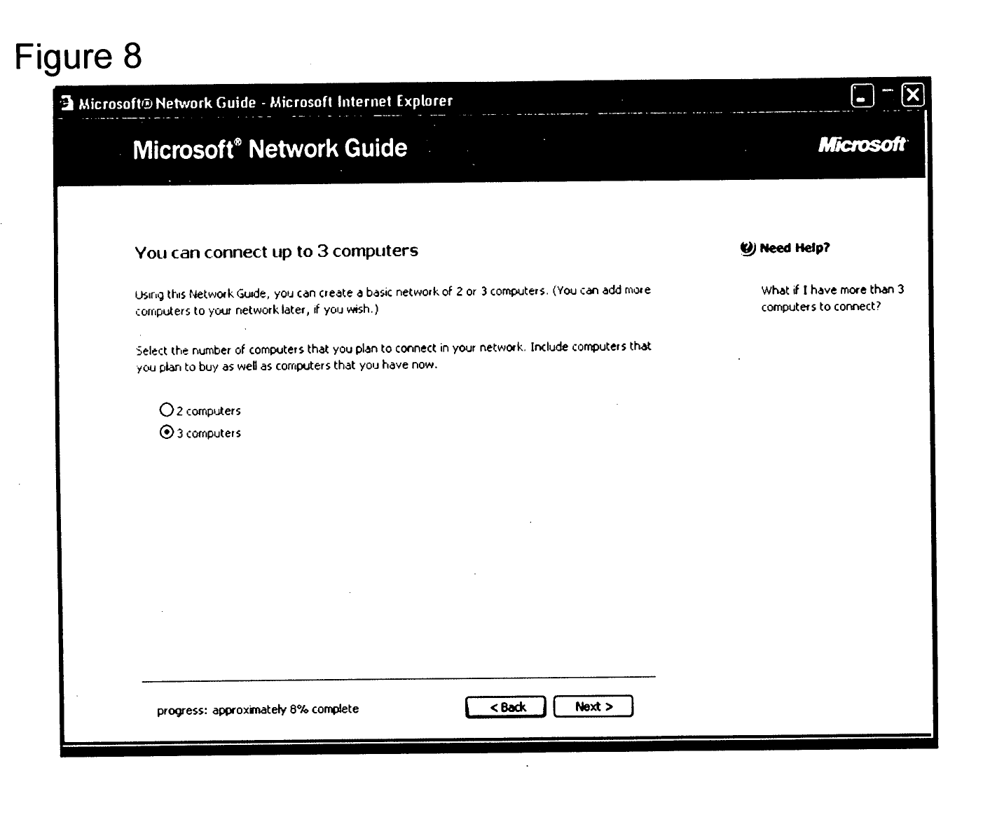

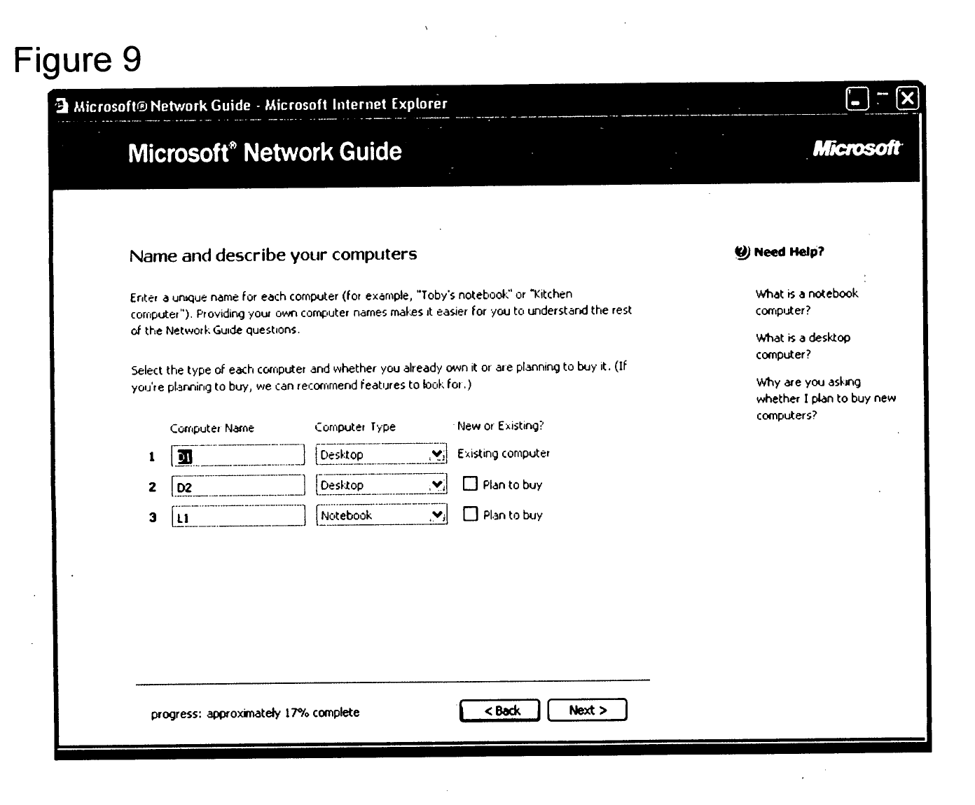

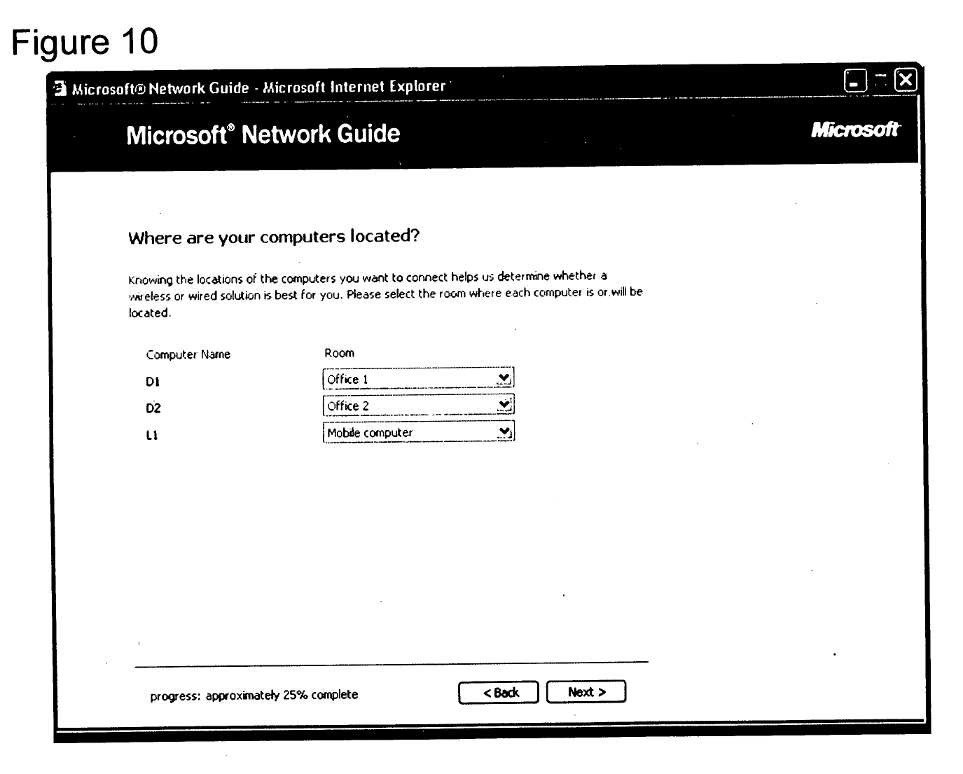

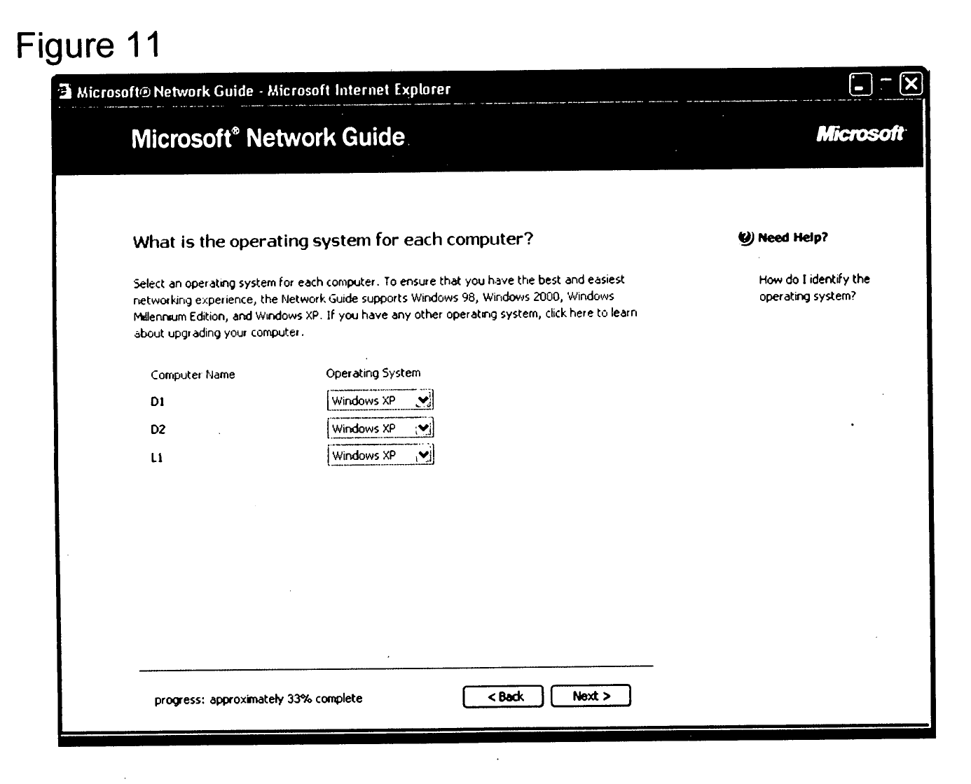

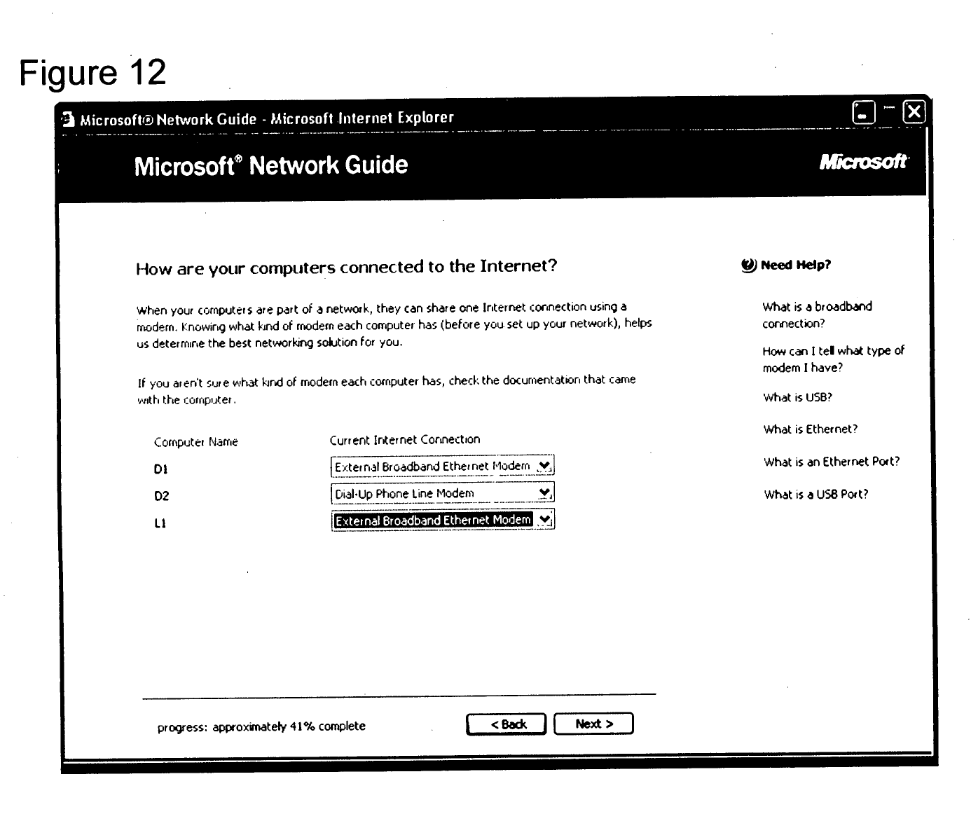

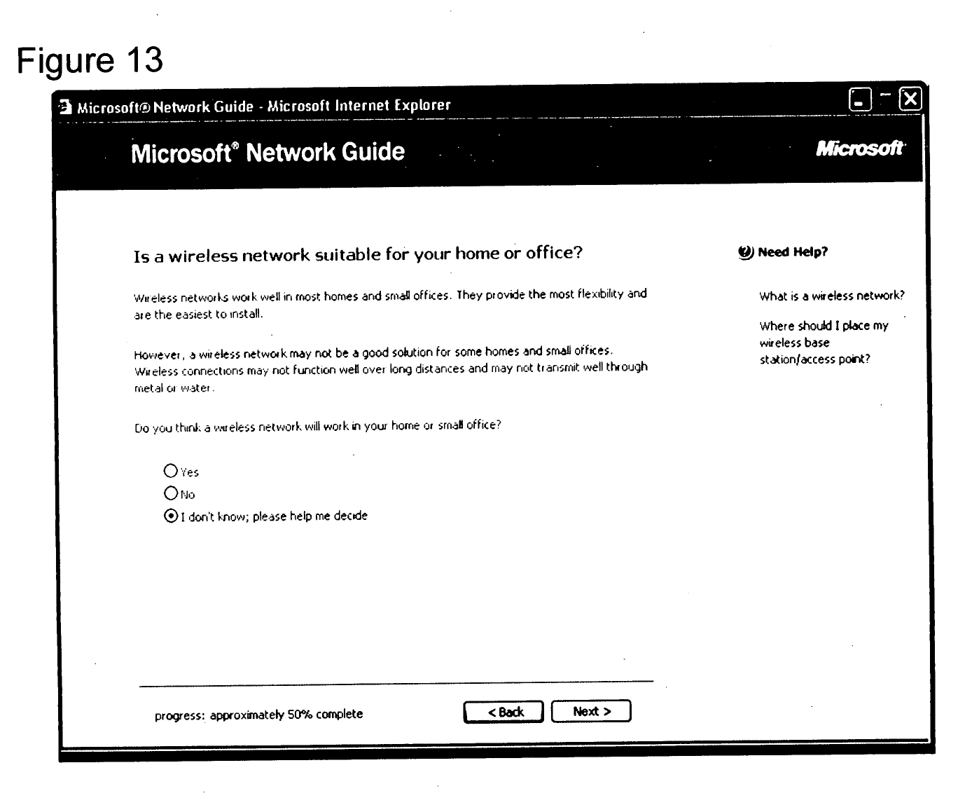

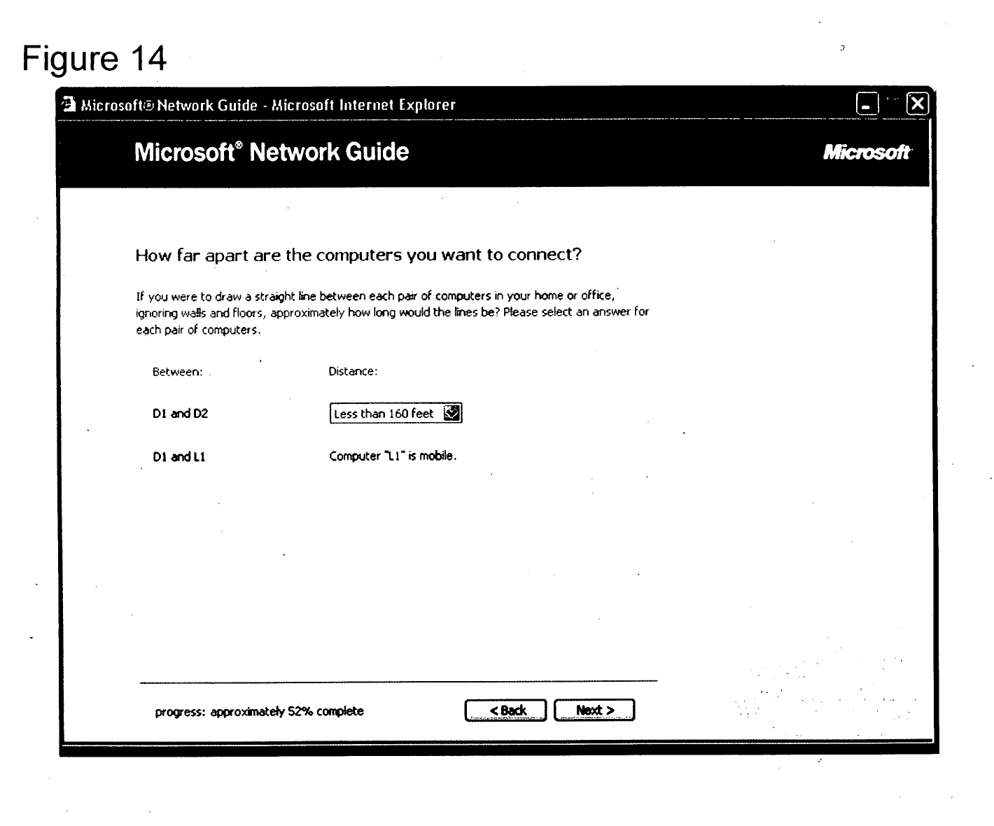

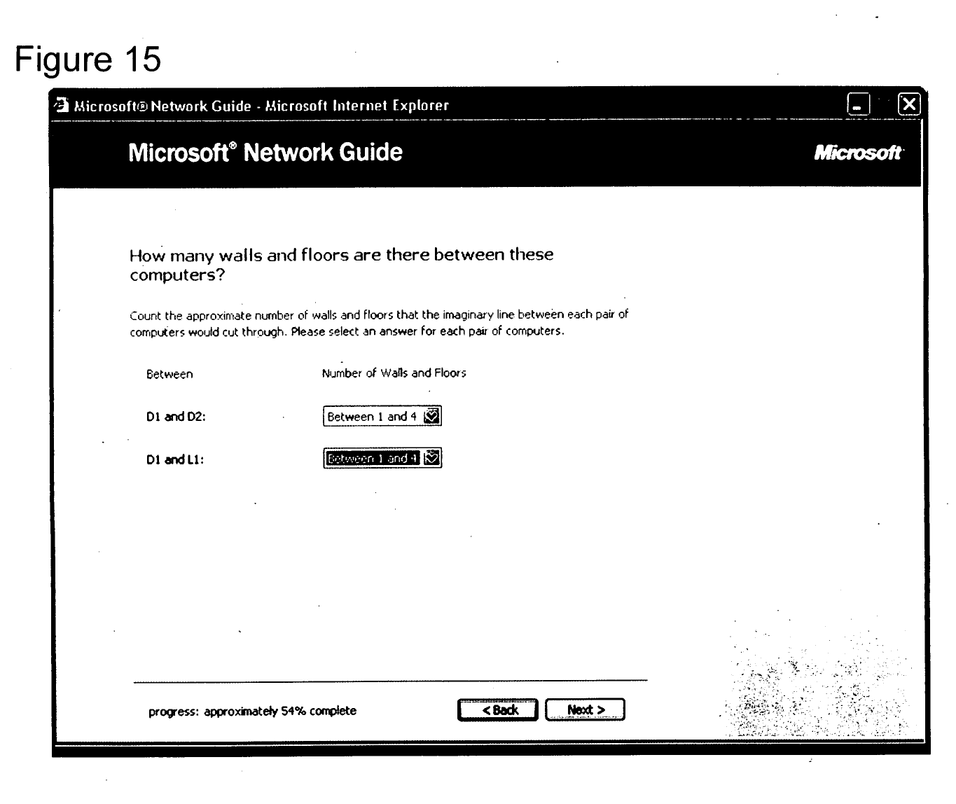

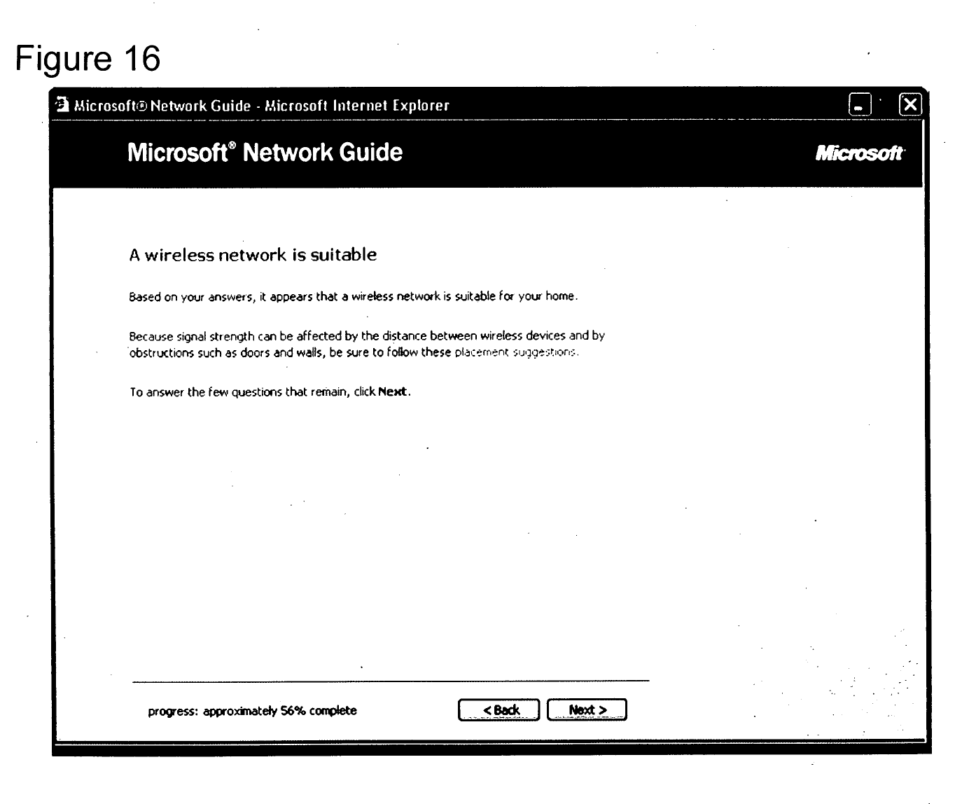

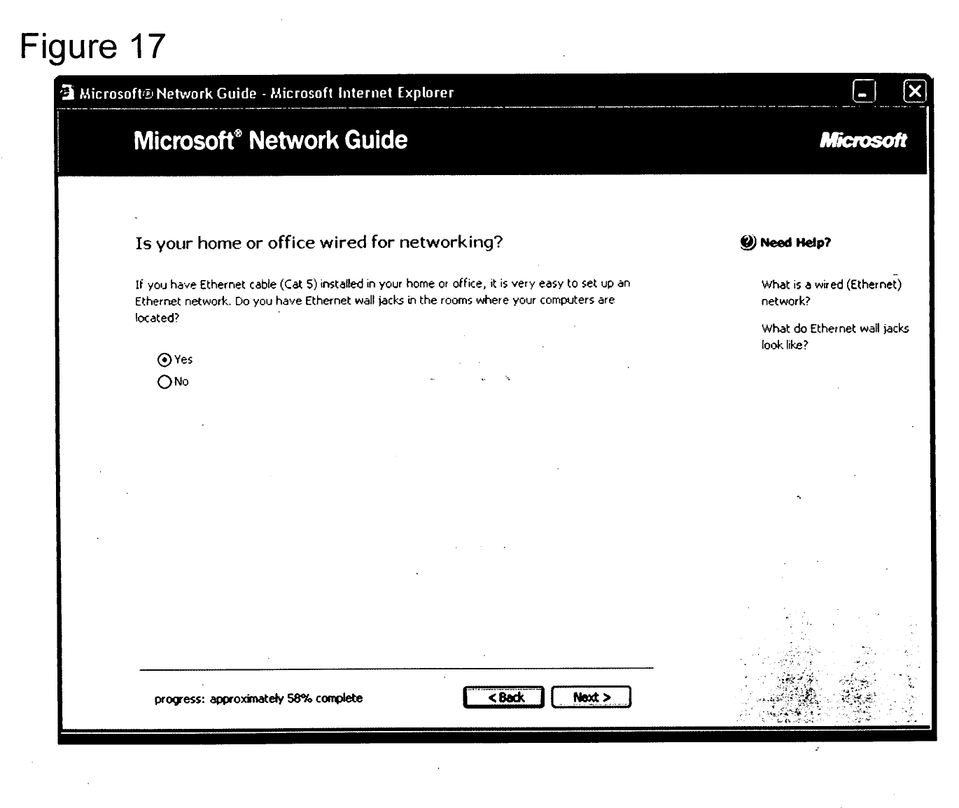

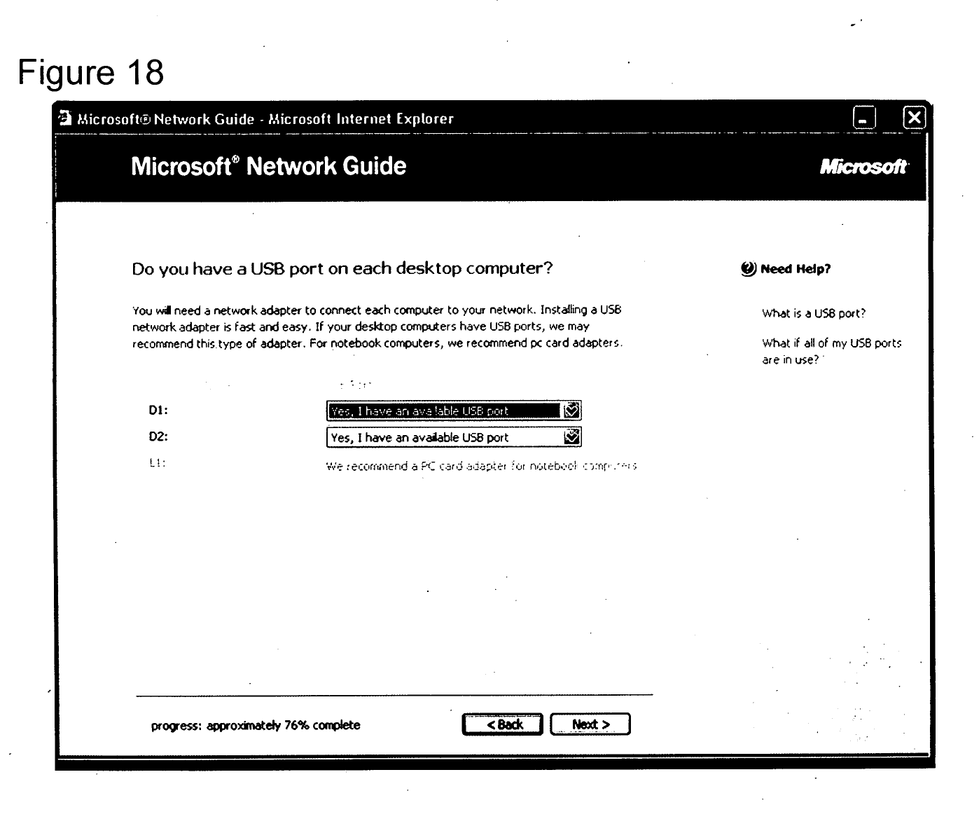

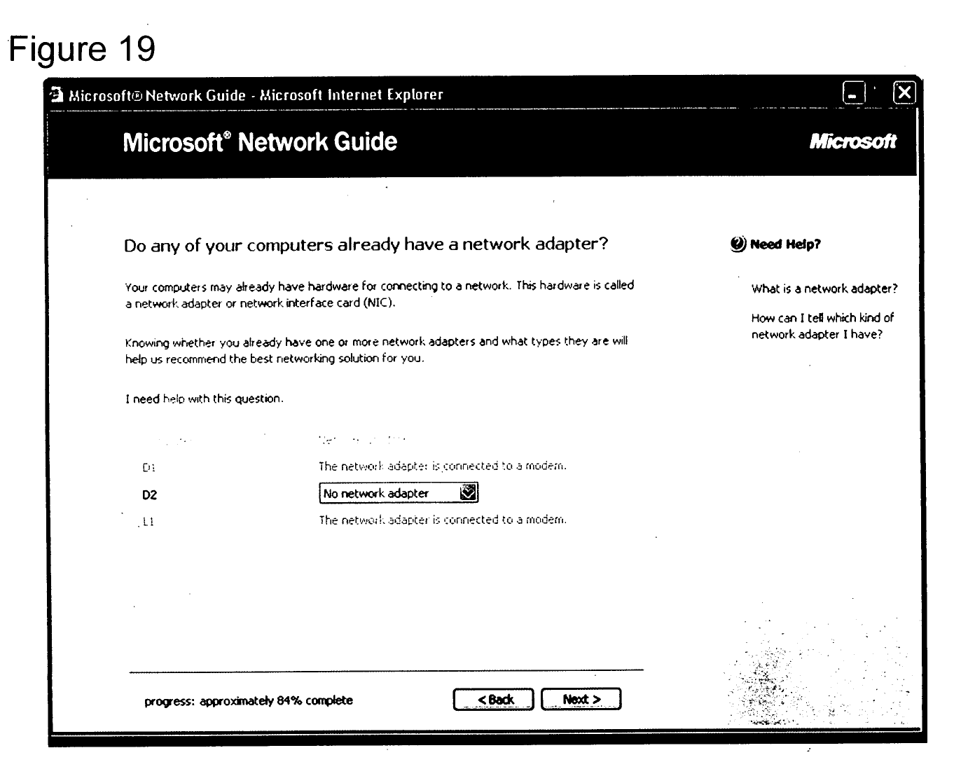

FIG. 5 depicts the architecture 500 and data flow of the interactive network guide 200 (FIG. 2). As discussed above in the general process flow 400, the interactive network guide first takes in user inputs by presenting a series of questions in a sequence of screen displays (such as the screen displays shown in FIGS. 8-19) to solicit user input characterizing the user's computers, and their environment in which they are to be deployed. The architecture 500 of the interactive network guide 200 includes a data collector component 520 that functions as a questions and user interface, error handler and data collector. The component 520 provides the screen display sequence that presents question prompts to the user for input of data for a set of variables (the raw input data 530), and performs client side checks for incorrect inputs. The component 520 stores this data collected from the user in a raw input data store 530.

The interactive network guide supports customization or branding of its displays, such as to include logos, product brand names, slogans, etc. on its question sequence and help screen displays, as well as configuring the appearance of the displays. The provider of the interactive network guide (e.g., a networking products vendor) performs this customization by editing a branding configuration and help configuration files 510, 512 to incorporate this branding-related content. The configuration files in the illustrated interactive network guide are XML format files, but proprietary or other format files can be used in alternative implementations. These configuration files configure the data collector component 520 to integrate the branding content into the question sequence screen displays and help screens of the guide. The branding configuration 510 allows the vendor to configure logos to appear in the screen displays, as well as colors, fonts and other appearance attributes. The help configuration 512 allows the vendor to place their own images (e.g., of their networking products) into the help topics instead of generic images of network equipment. The text of the help topics is also contained in the help configuration 512.

The raw input data 530 collected by the data collector component 520 in the illustrated interactive network guide includes data defining the following information for the user's computers:
1. a total number of computers (e.g., an integer between 1 and 3, although alternative guide implementations can support higher number of computers)
2. name of each computer (e.g., a text string)
3. whether each computer is a desktop or laptop computer (e.g., a numerical or Boolean value indicating desktop or laptop)
4. whether each computer is already owned or planned to purchase (e.g., a numerical or Boolean value indicating owned or planned purchase)
5. each computer's location (e.g., a textual or numeric value identifying a room location of the computer, such as office1, office2, office3, kitchen, family room, den, bedroom1, bedroom2, bedroom3, dining room, living room, other, or etc.)
6. each computer's operating system (e.g., a textual or numeric value identifying the operating system, such as Windows XP, Windows 2000, Windows ME, Windows 98, or etc.)
7. each computer's modem type (e.g., a textual or numeric value indicating the type of modem, such as external broadband Ethernet modem, external broadband USB modem, dial-up phone line modem, internal broadband modem, not connected to Internet, or etc.)
8. whether each computer has an available USB port (e.g., a numeric or Boolean value indicating whether the computer has an available USB port)
9. whether each computer has a network interface card (NIC) (e.g., a numeric or Boolean value indicating whether the computer has a NIC)
10. each computer's NIC type (e.g., a textual or numeric value indicating the type of NIC, such as none, Ethernet adapter, built-in Ethernet adapter, wireless adapter, or etc.)
11. for laptop computers, whether each computer has a PCMCIA slot (e.g., a numeric or Boolean value indicating the computer has such slot)
12. whether each computer has a printer attached (e.g., a numeric or Boolean value indicating the computer has an attached printer)
13. whether wireless networking is suitable for each computer (e.g., a numeric or Boolean value indicating whether wireless networking is suitable for the computer and its intended environment, such as based on distance and number of walls from the primary computer and whether it is a laptop)
14. whether a phone jack is available for each computer (e.g., a numeric or Boolean value indicating whether a phone jack is available at the computer's location).

In other alternative implementations of the interactive network guide, the raw input data can include fewer or additional items of information as to the user's computers and the environment in which they are deployed, as well as different data types.

After collecting the raw input data from the user, the interactive program guide develops one or more network designs suitable to the user's situation. The interactive program guide includes an option generator 540 that processes the raw input data 530 to determine a primary computer, possible connection media, and prioritized list of possible topologies. For these determinations, the option generator 540 includes components implementing a primary PC heuristic 542, a connection media type heuristic 543 and a network topology heuristic 544. These heuristics are further detailed in following sections.

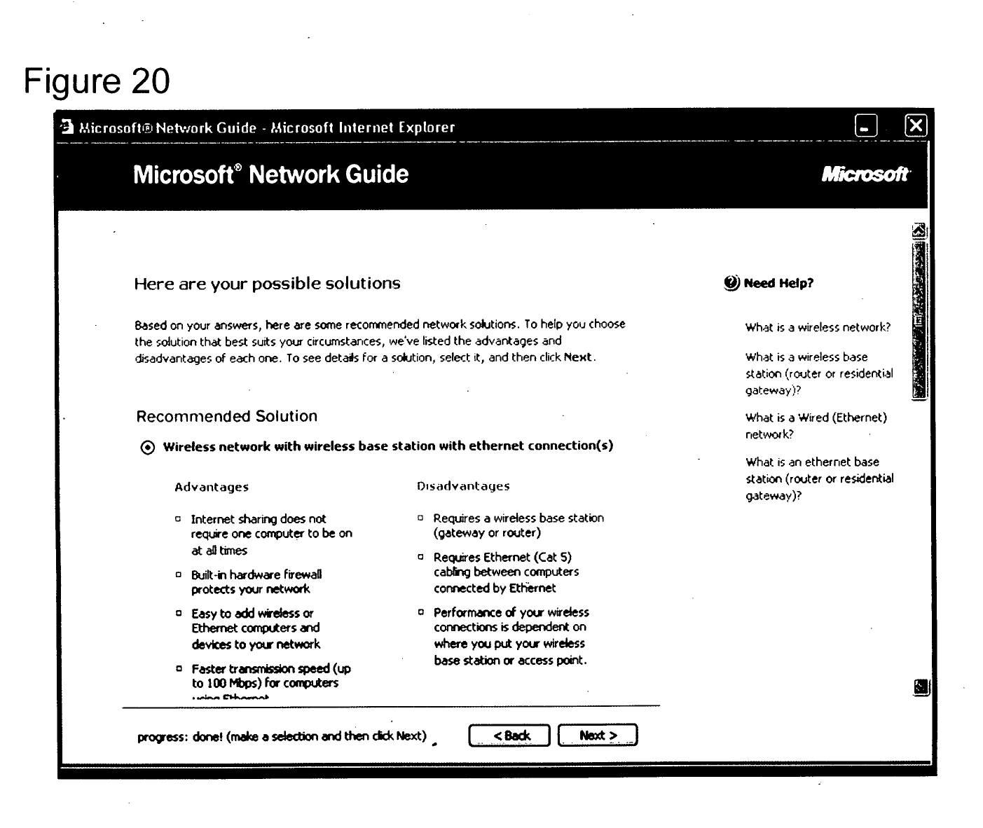

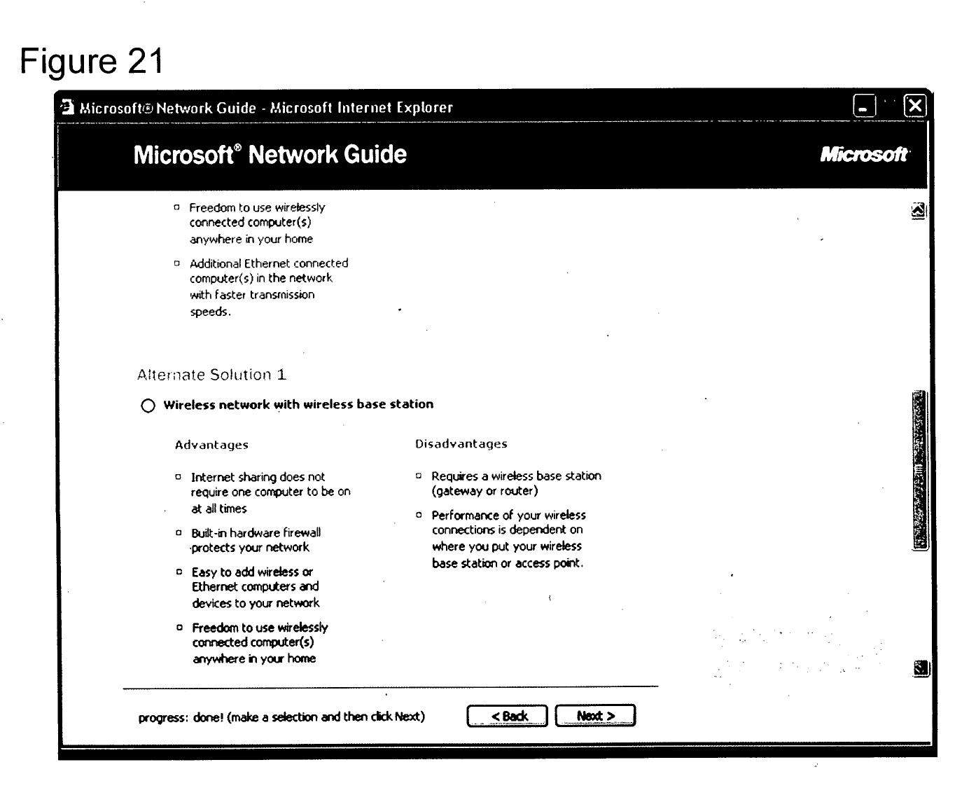

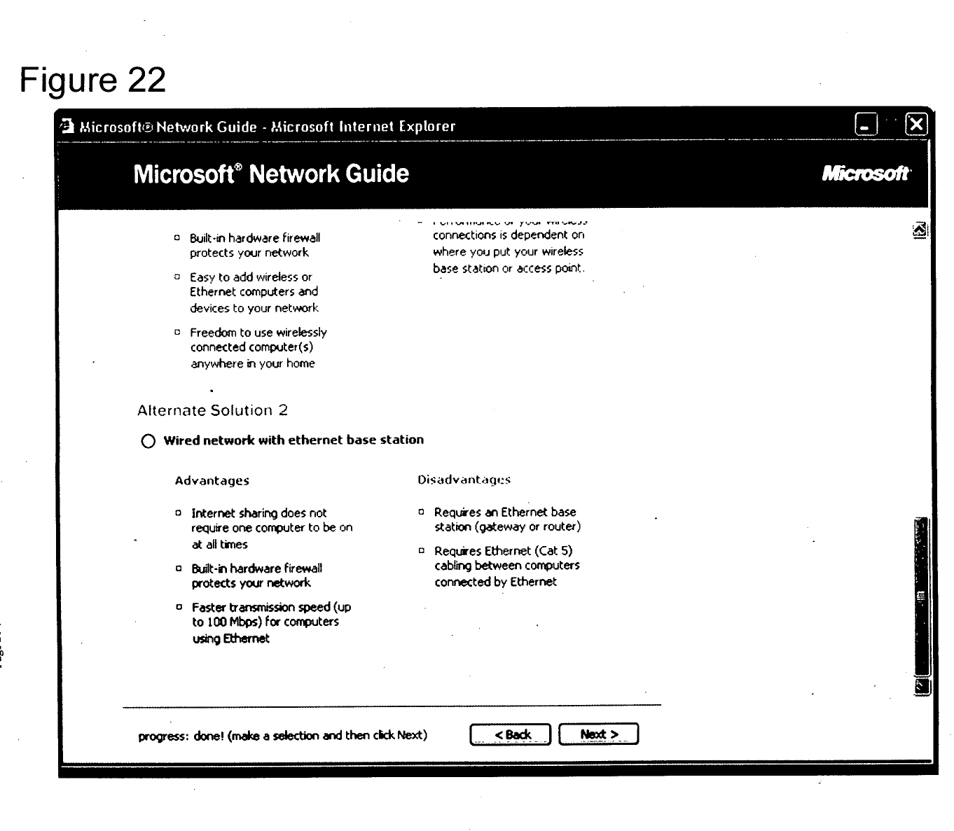

The interactive network guide further includes an options display/selection component 550. This component 550 presents a display of the one or more suitable network design alternatives generated by the options generator 540, such as a textual description of the alternatives and their benefits and disadvantages. The options display/selection component 550 also provides user interface controls for the user to select one of the presented alternative network designs. An example of screen displays of a recommended and alternative network designs, and user selection input is shown in FIGS. 20-22. Upon user selection of one of the alternative network designs, the options display/selection component 550 produces a master data set 564 for the selected network design. The master data set 564 is an XML format file in the illustrated architecture 500. The master data set 564 provides the input data for generating the network diagram, shopping list and instructions corresponding to the selected network design.

The interactive network guide then includes a diagram generator 571, a shopping list generator 572 and an instruction generator 573 that generate the final output 580 of the network guide, including a network diagram 581, shopping list 582 and setup instructions 583, respectively, for the network design that was selected by the user from the alternatives presented by the guide. These various outputs are generated from the master data that describes the selected network design, together with data from a product configuration 560 and instructions 562. The product configuration file 560 includes detailed data for various networking products used in the various alternative network designs produced by the interactive network guide. This data can include product names and IDs, a hyperlink (URL) to a web page or site of an on-line store from which the respective products can be purchased, description and images of the products, and advantages and benefits of network topologies using the products. The instructions file 562 includes text for setup instructions. The product configuration and instructions files also are XML format files.

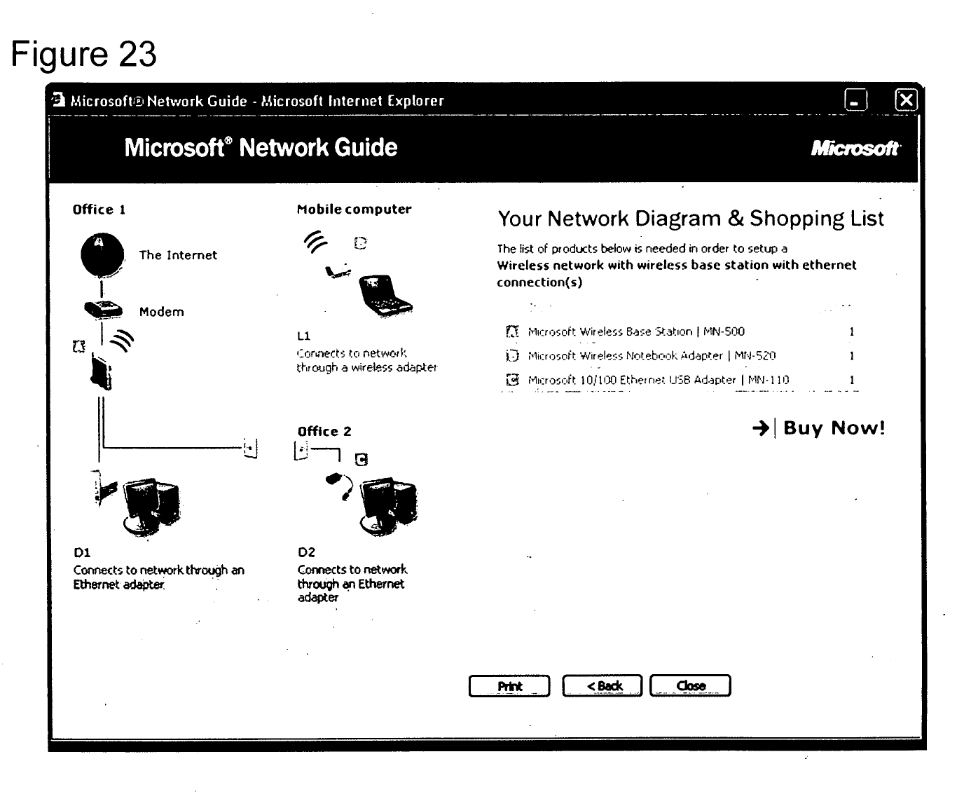

The diagram generator 571 takes the master data 564 describing the selected network design, and builds the network diagram 581. The diagram generator 571 transform data points from the master data into (x,y) coordinates at which to place product images from the product configuration 560 to dynamically build the network diagram 581. The resulting network diagram 581 is dynamically displayed to the user as a result of the user selection of the network design, such as in the example screen display shown in FIG. 23.

The shopping list generator 572 takes the master data 564 describing the selected network design, and transforms the data points into a list 582 of networking equipment needed for purchase by the user to build the selected network design. The shopping list generator 572 pulls the product name and ID, URL, and description of the products in the generated shopping list from the product configuration. The shopping list generator 572 dynamically displays this shopping list 582 to the user in response to the user selecting the network design from the suitable alternatives presented by the interactive network guide, such as in the example screen display shown in FIG. 23.

The instruction generator 573 takes the master data 564 describing the selected network design, and transforms the data points into setup instructions specific to the selected network design. The instruction generator 573 draws the text of the setup instructions from the instructions file 562. The instruction generator 573 dynamically displays these setup instructions in response to the user's selection of the network design from the alternatives presented by the option display/selection component 550.

5. Raw Input Data

As discussed above, the data collector component 520 of the interactive network guide present questions (as shown in the example screen displays in FIGS. 8-19) and gathers input data from the user describing the user's computers and environment. The following table details specific questions asked, and the corresponding types of the data variables that are collected from the user input in the illustrated implementation of the interactive network guide. This data can be represented in other data types in alternative implementations:

TABLE 1
General Questions

| | | Possible | When to | |
|---|---|---|---|---|
| Input Parameter | Type | values | ask/Notes | Default |
| TotalNumberOfComputers | int | [2, 3] | Always | 2 |
| Comp[n].Name | string | [<20 | Always | Computer |
| | | chars] | | [n] |
| Comp[n].isDesktop | bool | [true, | Always | true |
| | | false] | | |
| Comp[n].AlreadyOwn | bool | [true, | Always | true |
| | | false] | | |
| Comp[n].Location | Room | [ref to a | Always | none |
| | | Room obj] | | |

TABLE 2
Computer Specific Questions (Ask the following for each computer only if
AlreadyOwn = yes)

| Input Parameter | Type | Possible values | When to ask/Notes | Default |
|---|---|---|---|---|
| Comp[n].OS | int | [1 = XP, | Always | 1 |
| | | 2 = 2K, | | |
| | | 3 = ME, | | |
| | | 4 = 98] | | |
| Comp[n].ModemType | int | [1 = Internal BB, | Always | 1 |
| | | 3 = External BB Ethernet Attached, | | |
| | | 4 = External BB USB Attached, | | |
| | | 5 = Dial up phone line modem, | | |
| | | 6 = Not Connected] | | |
| Comp[n].USBPortType | int | [1 = USB exists and available, | Always | 1 |
| | | 2 = USB exists but not available, | | |
| | | 3 = USB doesn't exist] | | |
| Comp[n].NICType | int | [1 = Ethernet, | Always | Select |
| | | 2 = Wireless, | Always | |
| | | 3 = HPNA, | Always | |
| | | 4 = Powerline] | Always | |

TABLE 3
Environment Specific Questions

| Input Parameter | Type | Possible values | When to ask/Notes | Default |
|---|---|---|---|---|
| EthernetSuitable | bool | [true, false] | Always | True |
| WirelessSuitable | bool | [true, false] | Always | True |
| Room[n].PhoneJackAvailable | bool | [true, false] | If (numRooms( ) >= n) | True |

6. Business Logic—Option Generator

As discussed above with reference to FIG. 5, the option generator 540 determines the best possible network topology, network media types, network configuration, and hands the display options module the list of prioritized possible network solutions. At a high level, the option generator takes in the raw input data 530 and determines the possible topologies by processing the data through the following heuristic steps:
1. Primary PC Heuristics to determine which PC would be the best suited to be the ICS machine or best suited to be the PC in the same room as the hardware gateway.
2. Connection Media Heuristics to determine whether it is possible to include wireless in any of the solutions, Ethernet between rooms if PCs are in different rooms, HPNA if PCs are in different rooms, PLC if PCs are in different rooms.
3. Hardware Gateway Possibility Heuristics to determine whether the solution can include a hardware gateway (base station) as a solution.
4. Physical Layout Pattern Heuristics to determine which physical pattern the computers are in.
5. Possible Network Solutions Heuristics to determine the best possible network based on the 4 heuristics above using the master network topology heuristics.

The hardware gateway possibility, physical layout pattern and possible network solutions heuristics are summarized in FIG. 5 as the network topology heuristic.

Primary PC Heuristic. The PC that is best suited to be the ICS machine or the PC in the same room as the hardware gateway is determined based on the values of the input data variables: computer modem type (Comp[n].ModemType), desktop or laptop (Comp[n].DesktopOrLaptop) and operating system (Comp[n].OS). These values are used to calculate a primary PC score according to the following table:

TABLE 4
Primary PC Score

| Computer info | Primary PC score for ICS |
|---|---|
| BB Ext Eth && D && XP | 18 |
| Int BB && D && XP | 17 |
| BB Ext USB && D && XP | 16 |
| BB Ext Eth && D && !XP | 15 |
| Int BB && D && !XP | 14 |
| BB Ext USB && D && !XP | 13 |
| BB Ext Eth && L && XP | 12 |
| BB Ext USB && L && XP | 11 |
| BB Ext Eth && L && !XP | 10 |
| BB Ext USB && L && !XP | 9 |
| Dial-up && D && XP | 8 |
| Dial-up && D && !XP | 7 |
| Dial-up && L && XP | 6 |
| Dial-up && L && !XP | 5 |
| None && D && XP | 4 |
| None && D && !XP | 2 |
| None && L && XP | 3 |
| None && L && !XP | 1 |

The primary PC scores of the user's computers are compared and the PC with the highest score is selected. This computer is marked as the primary PC in the master data 564.

In cases where there are two computers with external broadband connections, the setup instructions generated by the interactive network guide recommend keeping the connection on the primary PC. If the broadband connection is on a laptop computer, the instructions recommend swapping to a desktop computer, if any.

Connection Media Heuristic. The connection media heuristic determines whether it is possible to include wireless in any of the solutions, Ethernet between rooms if the computers are in different rooms, phone-line networking (HPNA) if computers are in different rooms, and power-line networking (PLC) if the computers are in different rooms. The Heuristic determines four Boolean variables: wireless possible (W), Ethernet possible (E), and HPNA possible. The wireless possible variable is true if the wireless suitable variable in the raw input data is yes (i.e., WirelessSuitable=true). The Ethernet possible variable is true if the location of the computers is the same, or the raw input data indicates the house is wired for Ethernet (i.e., HouseWired=true). The HPNA possible is true if each computer's location is indicated in the raw input data to have a phone jack (i.e., Room[n].PhoneJackAvailable=true). A further possibility, powerline possible (P), is assumed true for all locations.

Hardware Gateway Possibility Heuristic. This heuristic determines whether the solution can include a hardware gateway (base station) as a solution. This determination is made by checking the internet connection of the computers in the raw input data. If any of the computer's modem type is “external broadband Ethernet attached” then a hardware gateway is considered possible.

Physical Layout Pattern Heuristic. This heuristic determines the physical pattern in which the computers are arranged in terms of rooms. The first PC listed in each of the layouts is the primary PC. Based on the room designated for each computer, the heuristic assigns one of the layouts from the possible permutations listed as follows:

| | | | | |
|---|---|---|---|---|
| Layout 1: | pc pc | | | // 2 PCs in the same room |
| Layout 2: | pc | \|pc | | // 2 PCs in different rooms |
| Layout 3: | pc | \|pc pc | | // 1 PC in 1 room, 2 PCs in another |
| Layout 4: | pc pc | \|pc | | // 2 PCs in 1 room, 1 PC in another |
| Layout 5: | pc | \|pc | \|pc | // 3 PCs in 3 different rooms |
| Layout 6: | pc pc pc | | | // 3 PCs in 1 room |

Master Network Topology Heuristic. After determining the general layout pattern, the option generator 540 maps the possible layouts together with the computer types to a set of all possible network topologies for the layout, as shown in the list below:

| | | | |
|---|---|---|---|
| 1. | Layout 1: | pc pc | // 2 PCs in the same room |

a) (D, D) = {EE,iE,EW,iP,iW}
a) (L, D) = {EE,WW,iE,iP,iW}
b) (D,L) = {EW,iW,EE,iE,iP}
c) (L,L) = {WW,EW,EE,iW,iE,iP}

| | | | | |
|---|---|---|---|---|
| 2. | Layout 2: | pc | \|pc | // 2 PCs in different rooms |

a) (D,D) = {EE,EW,iE,iW,iP,iH,EP,EH }
b) (L,D) = {EE,WW,iE,iW,EP,EH,iP,iH }
c) (D,L) = {EW,iW,EE,iE,iP,iH,EP,EH }
d) (L,L) = {WW,EW,EE,EP,EH,iW,iE,iP,iH }

| | | | | |
|---|---|---|---|---|
| 3. | Layout 3: | pc | \|pc pc | // 1 PC in 1 room, 2 PCs in another |

```
a) (D,D,D) = {EEE,EWW,iEE,iWW,iPP,iHH,EPP,EHH}
b) (L,D,D) = {EEE,WWW,iEE,iWW,EPP,EHH iPP,iHH }
c) (D,D,L) = {EEW,EWW,EEE,iEW,iWW,iEE,iPP,iHH,EPP,
    EHH}
d) (L,D,L) = {EEW,EWW,EEE,iEW,iWW,iEE,EPP,EHH iPP,
    iHH }
e) (D,L,L) = {EWW,EEE,iWW,iEE,iPP,iHH,EPP,EHH}
f) (D,L,D) = {EWE,EWW,EEE,iWE,iWW,iEE,iPP,iHH,EPP,
    EHH}
g) (L,L,D) = {WWW,EWE,EEE,iWE,iWW,iEE,EPP,EHH,iPP,
    iHH }
h) (L,L,L) = {WWW,EEE,EPP,EHH,iWW,iEE,iPP,iHH}
```

| | | | | |
|---|---|---|---|---|
| 4. | Layout 4: | pc pc | \|pc | // 2 PCs in 1 room, 1 PC in another |

```
a) (D,D,D) = {EEE,EEW,EWW,iEE,iEW,iWW,iEP,iPP,iEH,EEP,
    EEH,EPP}
b) (L,D,D) = {EEE,EEW,WWW,iEE,iEW,iWW,EEP,EEH,EPP,
    iEP,iPP,iEH }
c) (D,D,L) = {EEW,EWW,EEE,iEW,iWW,iEE,iEP,iPP,iEH,EEP,
    EEH,EPP}
d) (L,D,L) = {EEW,WWW,EEE,iEW,iWW,iEE,EEP,EEH,EPP,
    iEP,iPP,iEH }
e) (D,L,L) = {EWW,EEE,iWW,iEE,iEP, iPP,iEH,EEP,EEH,EPP}
f) (D,L,D) = {EWE,EWW,EEE,iWE,iWW,iEP,iPP,iEH,EEP,
    EEH,EPP}
g) (L,L,D) = {WWW,EEE,iWE,iWW,EEP,EEH,EPP,iEP,iPP,
    iEH}
h) (L,L,L) = {WWW,EEE,EEP,EEH,EPP,iWW,iEE,iEP,iPP,iEH}
```

| | | | | | |
|---|---|---|---|---|---|
| 5. | Layout 5: | pc | \|pc | \|pc | // 3 PCs in 3 different rooms |

```
a) (D,D,D) = {EEE,EWW,iEE,iWW,iPP,iHH,EPP,EHH}
b) (L,D,D) = {EEE,WWW,iEE,iWW,EPP,EHH,iPP,iHH }
c) (D,D,L) = {EEW,EWW,EEE,iEW,iWW,iEE,iPP,iHH,EPP,
    EHH}
d) (L,D,L) = {WWW,EEW,EEE,iEW,iWW,iEE,EPP,EHH,iPP,
    iHH}
e) (D,L,L) = {EWW,EEE,iWW,iEE,iPP,iHH,EPP,EHH}
f) (D,L,D) = {EWE,EWW,EEE,iWE,iWW,iEE,iPP,iHH,EPP,
    EHH}
g) (L,L,D) = { WWW,EWE,EEE,iWE,iWW,iEE,EPP,EHH,
    iPP,iHH }
h) (L,L,L) = {WWW,EEE,EPP,EHH,iWW,iEE,iPP,iHH}
```

| | | | |
|---|---|---|---|
| 6. | Layout 6: | pc pc pc | // 3 PCs in 1 room |

a) (D,D,D) = {EEE, iEE, iPP, EPP}
b) (L,D,D) = {EEE, WWW, iEE, iPP, EPP}
c) (D,D,L) = {EEW, EEE, iEW, iEE, iPP, EPP}
d) (L,D,L) = {WWW, EEE, iEW, iEE, iPP, EPP}
e) (D,L,L) = {EWW, EEE, iWW, iEE, iPP, EPP}
f) (D,L,D) = {EWE, EEE, iWE, iEE, iPP, EPP}
g) (L,L,D) = {WWW, EEE, iWE, iEE, iPP, EPP}
h) (L,L,L) = {WWW, EEE, EPP, iWW, iEE, iPP}

The set of all possible network topologies for the respective layout is represented in the above list in codes conforming to the following rules:
1. All upper case letters represents a hardware gateway solution
2. When all letters are upper case, the letter stands for the specific kind of media that connects that PC to the gateway.
a) i.e. ‘EE’ means 2 PC's connected via Ethernet to a hardware gateway
b) i.e. ‘EW’ means 1 PC connected via Ethernet and 1 via wireless to hardware gateway
3. The letter ‘i’ represents an ICS solution where the other letter(s) represent how the other computer(s) are connected to the ICS Host machine.
4. E means Ethernet
5. W means wireless
6. P means Powerline
7. H means HPNA.

Possible Network Solutions Heuristic. After determining the set of all possible network topologies for the physical layout, the options generator uses the possible network solution heuristic to determine the suitable network topologies. The options generator runs through the set of all possible topologies for the layout, and eliminates those that are not possible based on the following rules:
Compu[n].Primary=true

Use this to determine the ordering in the master heuristics table
WirelessPossible=[True, False]

If wireless is not possible, eliminate all options with the letter ‘W’ in the solution
EthernetPossible=[True, False]

If Ethernet is not possible, eliminate all options with the letter ‘E’ represents the connection to a pc not in the same room as the primary PC.

If it is the first letter, that means that the primary PC is connected via Ethernet, which is ok.
HPNAPossible=[True, False]

If HPNA is not possible, then eliminate all options with the letter ‘H’ in the solution.
HardwareGatewayPossible=[True, False]

If HardwareGateway is not possible, then eliminate all options that have all upper case letters.
LayoutPattern=[1,2,3,4,5,6]

Use this to determine which layout to reference.

Key assumptions of Heuristics. The above discussed heuristics implemented by the options generator 540 are based on a number of key assumptions, which may be varied in alternative implementations. These assumptions are as follows:
1. Connection Technology Priorities
   a) Different Rooms
   i) #1 Wireless
   ii) #2 Ethernet
   iii) #3 PLC
   iv) #4 HPNA
   b) Same Room
   i) #1—Ethernet for Desktop, Wireless for Laptop
   ii) #2—Wireless for Desktop, Ethernet for Laptop
   iii) #3 PLC
2. Internet connection=YES on at least 1 machine
3. For purely wireless network, we must message to the user the security risks of wireless setup and explain to them that they have the option to temporarily connect via Ethernet to the RG for setup and then remove the cable.
4. Recommendations are based on the following order:
   a) E & W RG's first
   b) ICS solutions (all)
   c) PLC RG
   d) HPNA RG
   e) This has one caviot: when the laptop is the primary PC, we show RG's before ICS because it is a bad user experience (i.e. not having the laptop there and on all the time) even though setup is more difficult and expensive.
5. Leave out internal Broadband modem on Laptop
6. ‘External Broadband Ethernet Attached’ modems are the only ones that hardware gateways connect to.
7. Only 2 technologies in one scenario, only merge EW, EP, EH variations.
8. Laptop will not be a primary PC, thus we removed all variations L,*,*, EXCEPT when all PC's are laptops.
9. If wireless is selected for one computer in “the other room” (i.e. laptop), we would not recommend a non-wireless solution (other than Ethernet) for the other room (i.e. PLC, HPNA).

7. Display Option/User Selection

As discussed in the architecture overview above, the options display/selection component 550 displays one or more suitable network topology options for the user to select (e.g., as in the example screen displays in FIGS. 20-22). The options display/selection component 550 displays these options together with descriptions of advantages and disadvantages of the respective topologies taken from the product configuration file 560.

In the illustrated interactive network guide, the options display/selection component 550 displays the top three options out of the prioritized list of possible network topologies produced by the options generator 540. The option generator 540 provides the set of possible topologies as a list of the coded options. The possible topology options for the various physical layouts of the user's computers are summarized in priority order in the following list. As discussed above, the network topology heuristics 544 of the option generator 540 (i.e., in the master network topology heuristic and possible network solutions heuristic discussed above) further shortens the list of possible topology options available for the physical layout by eliminating any unsuitable options. The options display/selection component 550 takes the top three options from the remaining set of suitable network topology options.

List of possible network topologies by physical layout:
1: EE, iE, EW, iP, iW, EW, WW
2: EE, EW, iE, iW, iP, iH, EP, EH, WW
3: EEE, EWW, iEE, iWW, iPP, iHH, EPP, EHH, EEW, iEW, EWE, iWE, WWW, EEE
4: EEE, EEW, EWW, iEE, iEW, iWW, iEP, iPP, iEH, EEP, EEH, EPP, EWE, iWE, WWW
5: EEE, EWW, iEE, iWW, iPP, iHH, EPP, EHH, EEW, iEW, iWW, EWE, EWW, iWE, WWW, iHH
6: EEE, iEE, iPP, EEW, iEW, EWW, iWW, EWE, iWE, WWW

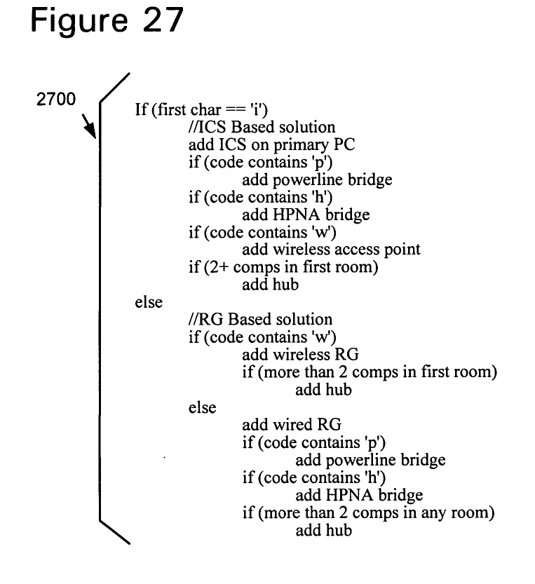

For displaying advantages and disadvantages, the options display/selection component 550 decodes the 2 and 3 letter codes of each of the options that are to be displayed, using the pseudo-code procedure listed in FIG. 27. The options display/selection component 550 then gathers the textual descriptions of advantages and disadvantages from the product configuration file 560 for the major components identified by the pseudo-code procedure from the network topology option codes. The options display/selection component 550 presents the advantages and disadvantages of each displayed network topology option as a bulleted list of the descriptions of advantages and disadvantages of all major components of the network topology. The resulting list is the overall advantages and disadvantages for the option. Accordingly, the advantages and disadvantages are not necessarily relative to the other recommended solutions (which may incorporate some of the same major components), but rather are absolute based on the included major components.

The user selects one of the options displayed by the option display/selection component 550, such as by clicking a radio button control and next button in the example screen displays in FIGS. 20-22. At this point, the interactive network guide produces the master data XML file 564 describing the selected option, that will be consumed by the diagram generator 571, shopping list generator 572 and instruction generator 573 (FIG. 5).

8. Master Data

The interactive network guide generates the master data 564 (FIG. 5) for the option selected by the user out of those displayed by the option display/selection component 550. The mater data 564 provides the input data for the diagram generator 571, shopping list generator 572 and instruction generator 573.

The master data 564 includes the raw input data 530 defined above, and additionally the data defined in the following table.

TABLE 5
Business logic and user selection-based data.

| | | Possible | | |
|---|---|---|---|---|
| Input Parameter | Type | Values | When to Ask/Notes | Default |
| GatewayBasedSolution | Bool | [true, false] | If code is all upper case, | n/a |
| | | | else ICS | |
| Comp[n].MediaToGateway | int | [1 = wireless, | Based on code letter in | n/a |
| | | 2 = Ethernet, | order | |
| | | 3 = HPNA, | | |
| | | 4 = PLC] | | |
| Comp[n].NICRequired | int | [1 = Ethernet | Based on code letter for | n/a |
| | | 2 = Wireless | that PC + Laptop/ | |
| | | | Desktop | |
| Comp[n].NICRequired.Have | Bool | [true, false] | Based on check to | n/a |
| | | | Comp[n].NICType | |
| EquipmentInRoom[n] | Bool | (all possible | | n/a |
| | | non NIC | | |
| | | equipment) | | |
| NeedAP | Bool | | Based on codes with W | n/a |
| | | | only or ICS with W | |
| NeedHub | Bool | [true, false] | Based on codes: | n/a |
| | | | If (Layout1 and ICS | |
| | | | with I, E, P) Etc. | |
| NumberCablesNeeded | Int | | | 0 |
| Layout | int | [1-6] | Based on Layout | 1 |

9. Diagram, Shopping List and Instruction Generators

As discussed above, the diagram, shopping list and instruction generators 571-573 (FIG. 5) take in the master data produced by the user selection of one of the displayed network design solutions (e.g., the option selection screen displays in FIGS. 20-22), and produce a network diagram, shopping list and setup instructions for the selected network design.

The network diagram generator 571 reads in the master data file 564 and transforms the data points to (x,y) coordinates within an image for displaying product images of the various network components that form the selected network design solution. The network diagram generator 571 retrieves the product images from the product configuration file, and displays the product images at these dynamically determined coordinates. As already discussed, the interactive network guide can be customized to a particular vendor's networking products line by editing or replacing the product configuration file to contain images, online shopping links, and text descriptions (including the advantages/disadvantages used in the product options screen display as shown in FIGS. 20-22) for the vendor's products. The network diagram generator 571 further dynamically customizes the network diagram for the user by displaying the location names and computer names input by the user in the network diagram. The network diagram generator 571 further includes product identifiers (e.g., “A,” “B,” etc.) to correlate the product images with the products listed in the shopping list. The network diagram generator thus dynamically generates a custom network diagram specific to the user's computers and their environment, so that the user can readily identify the user's own computers and locations referenced on the diagram, as well as the network products that will need to be purchased and assembled to construct the network.

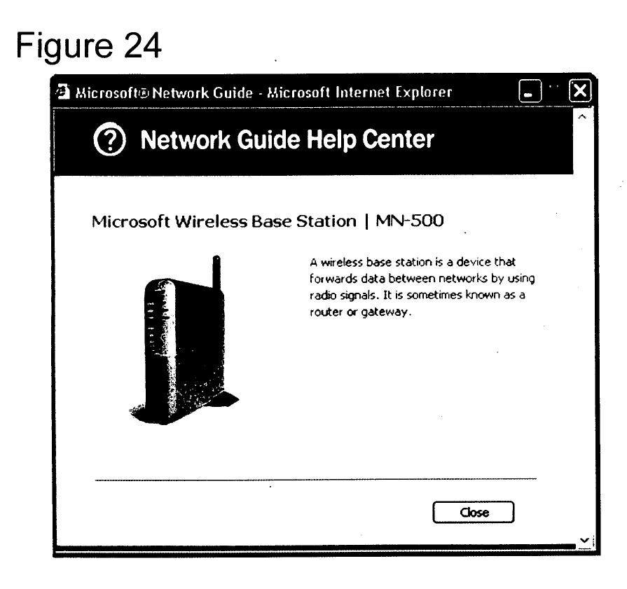

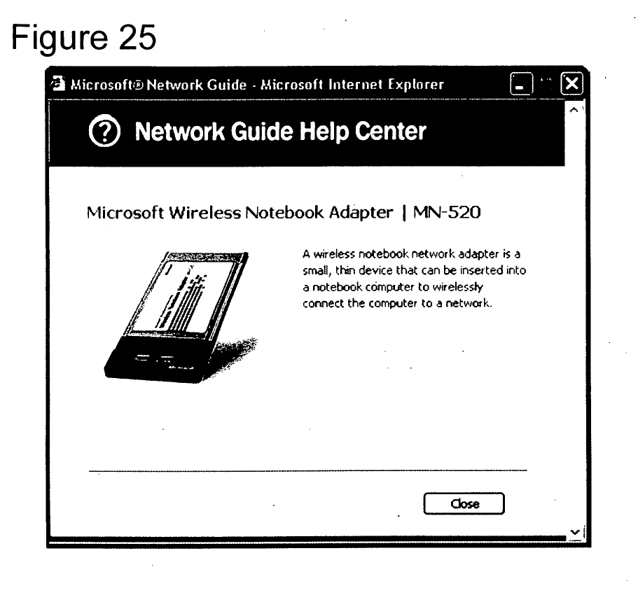

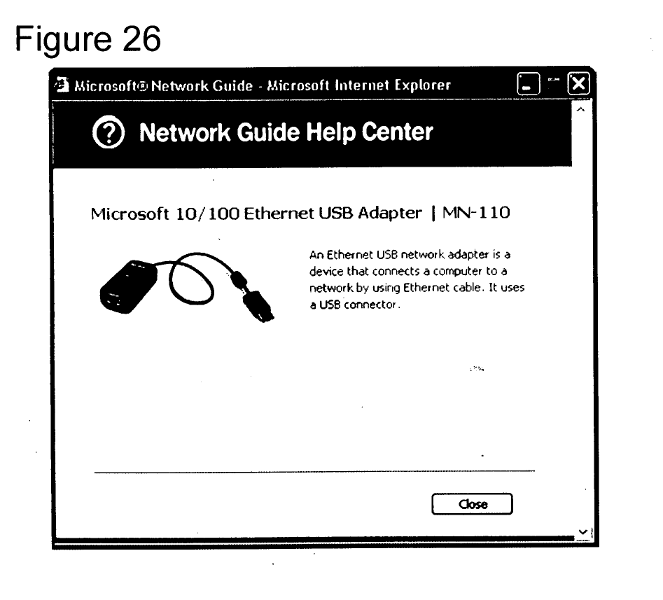

The shopping list generator 572 likewise takes the master data file 564 and transforms the data points for the selected network solution into a set of the networking equipment that the user will need to purchase to construct the network. The shopping list generator retrieves the appropriate product names from the product configuration file 560. As already remarked, the product configuration file can be customized to a particular vendor so as to include details of the vendor's line of networking products. This customization can include on-line shopping links (e.g., for the web application version of the interactive network guide) to allow the user to purchase the products immediately via an on-line store (e.g., the “buy-now” hyperlink in the example shopping list screen display shown in FIG. 23). In various implementations, the shopping list generator can provide links to pricing information, a link to add the listed products to an on-line shopping cart, links to larger images or further information on individual products (such as shown in FIGS. 24-26), etc. The shopping list generator further includes product identifiers (e.g., “A,” “B,” etc.) to correlate the listed products with those depicted in the network diagram. Preferably, the shopping list generator omits those networking products that the user has indicated are already owned (e.g., Ethernet adapters are not listed for computers that the user has indicated already include an Ethernet adapter). The shopping list generator thus dynamically generates and displays a list of the products needed for purchase to construct the network, such as in the example shopping list shown in FIG. 23.

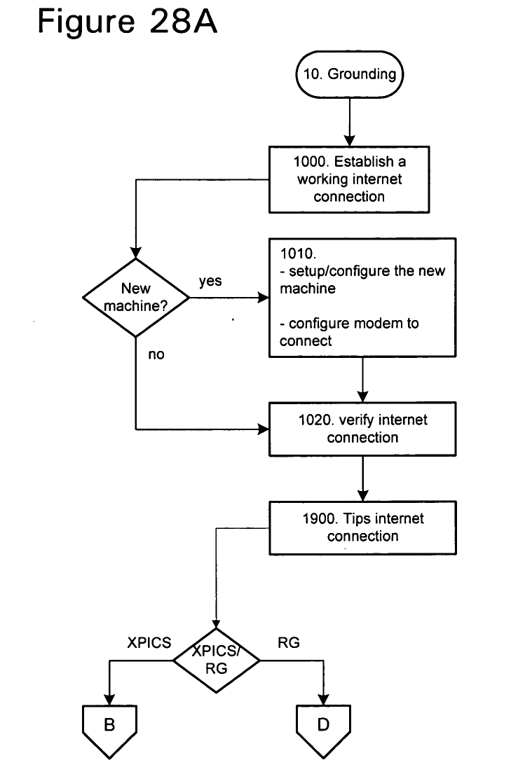

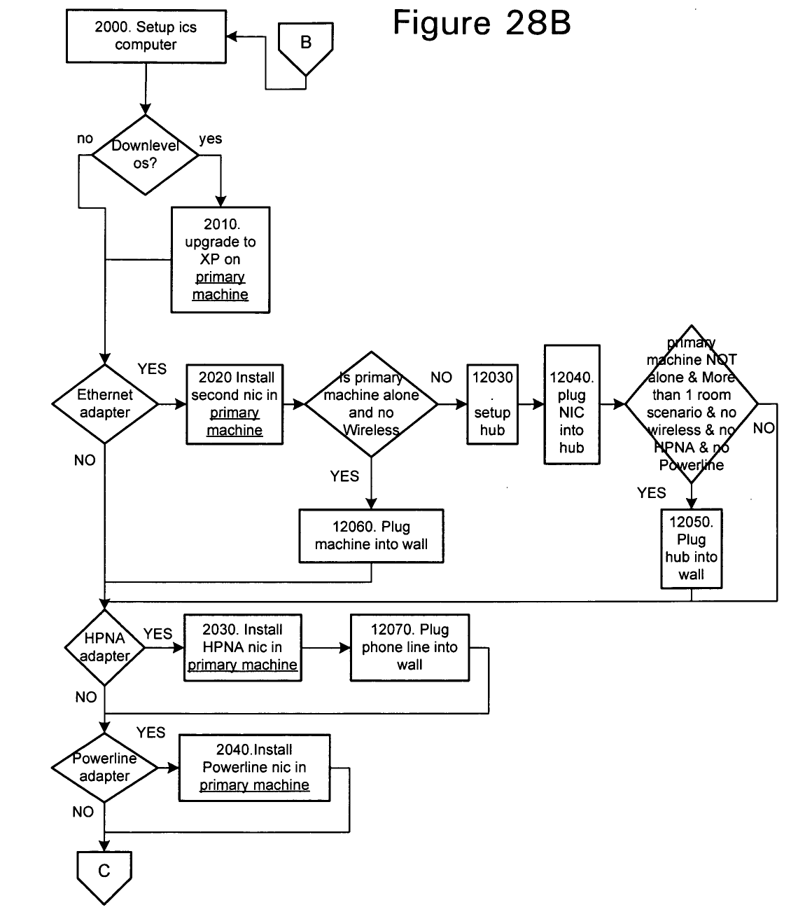

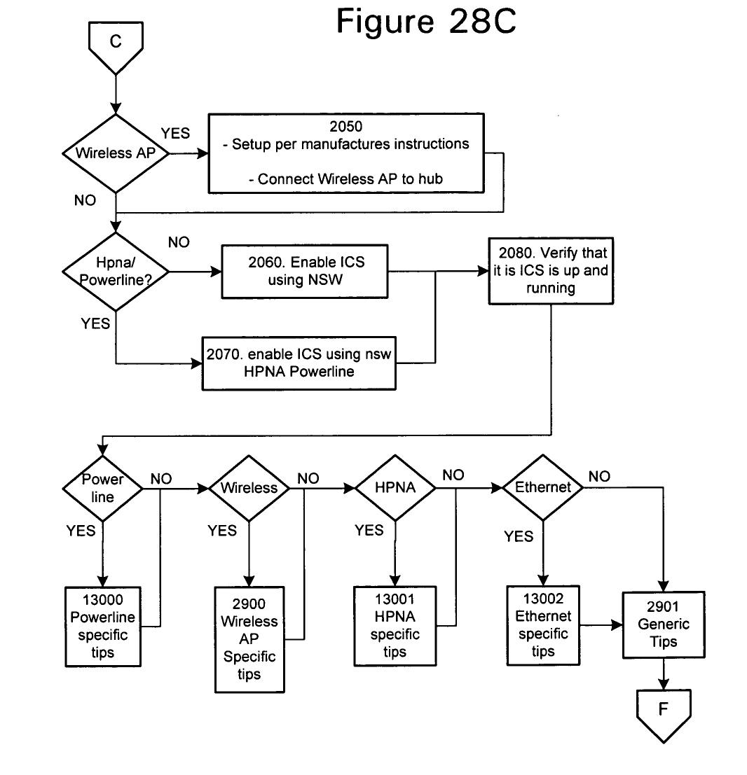

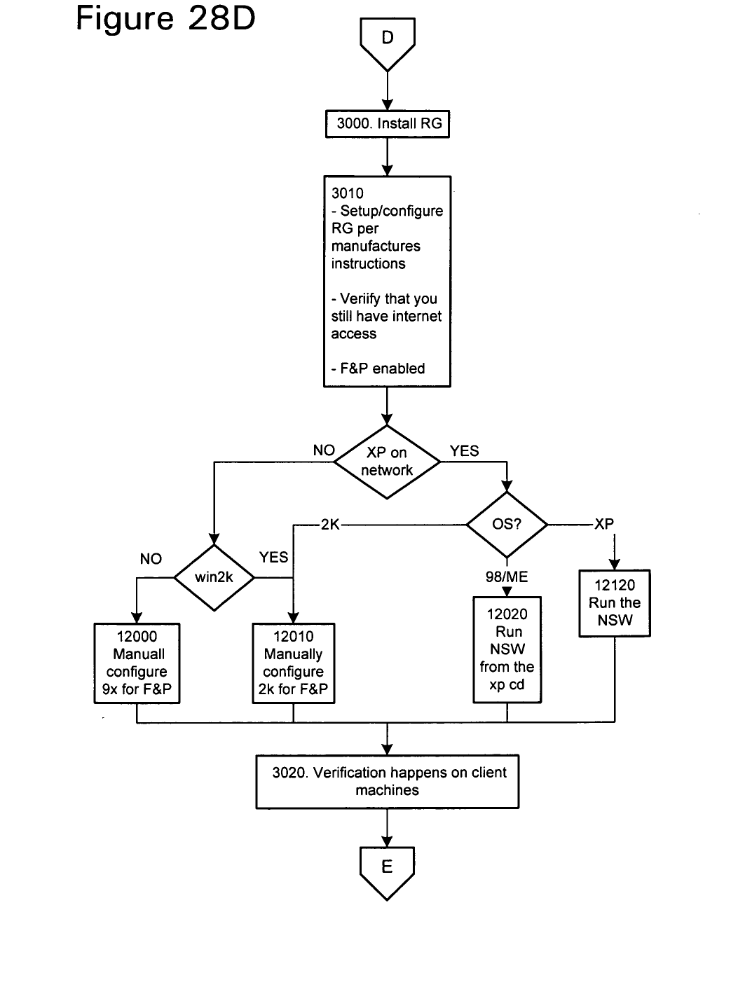

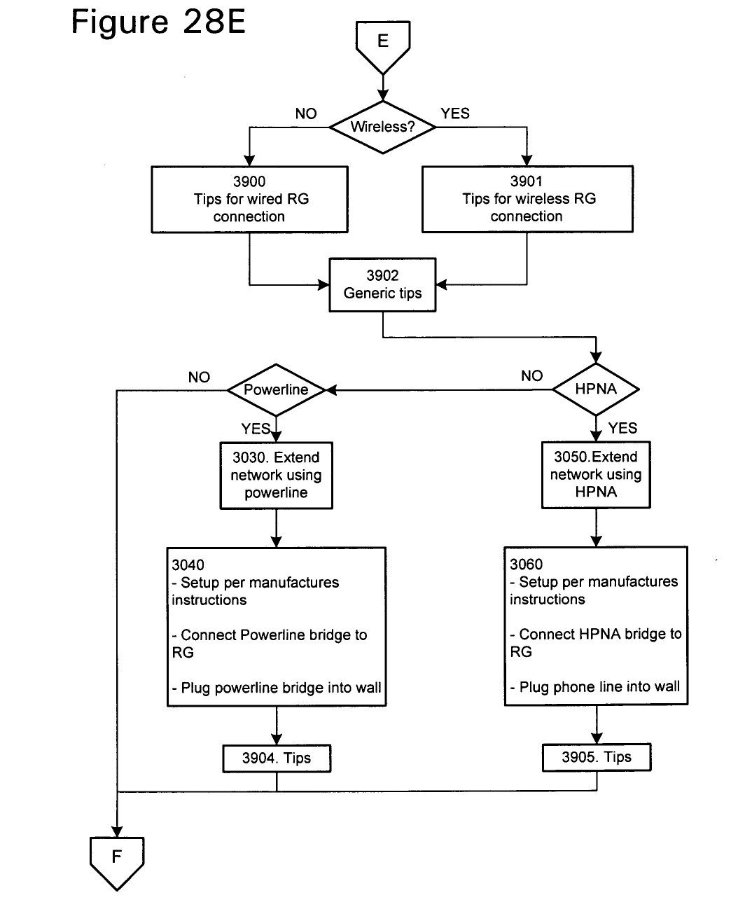

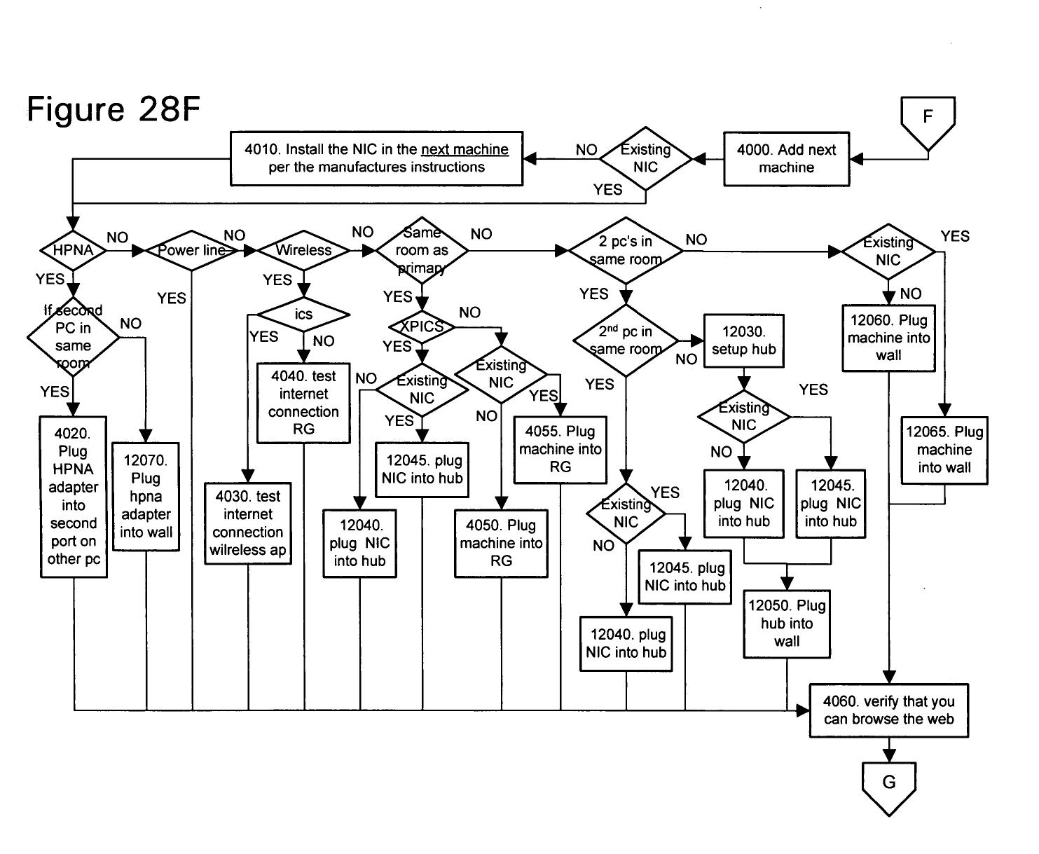

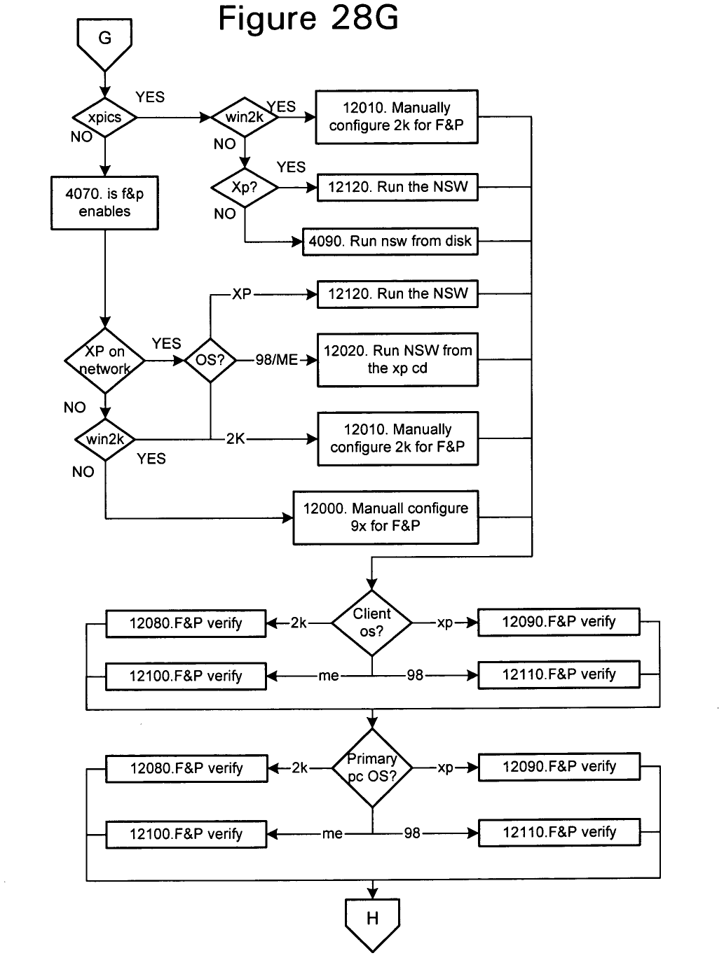

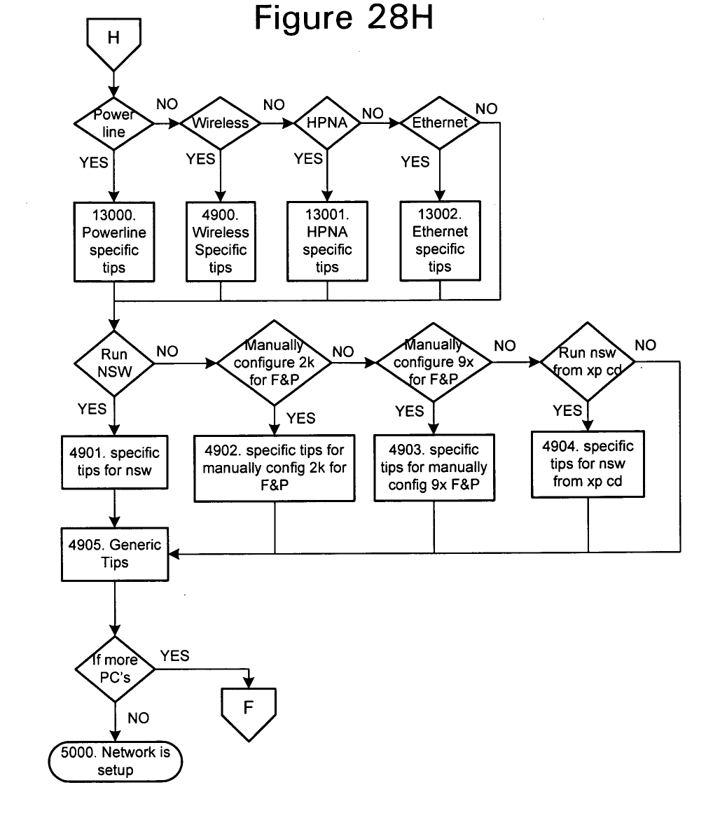

The instruction generator 573 also reads the details of the selected network solution option from the master data file 564, and dynamically generates a list of setup instructions for constructing the network. In the illustrated interactive network guide, the instruction generator 573 dynamically generates the setup instructions by following the instruction building procedure depicted in the flow chart of FIGS. 28A-H. The depicted procedure determines which instructions to include into the generated setup instructions based on the details of the selected network solution option represented in the master data file. The instruction generator 573 customizes the setup instructions to the user by using the custom computer names and locations input by the user, and also customizes the instructions to the network products identified in the network diagram and shopping list. The instruction generator 573 thus dynamically produces setup instructions specific to the user's selected network solution, and displays the setup instructions.

In view of the many possible embodiments to which the principles of our invention may be applied, we claim as our invention all such embodiments as may come within the scope and spirit of the following claims and equivalents thereto.

1. A computer-based method of assisting a user to design a network for a group of computers, the method comprising:
interactively presenting a sequence of questions to the user relating to characteristics of the group of computers and their environment of use;
gathering input data of the user's responses to the questions;
evaluating the input data to determine a prioritized set of network solutions suitable for the group of computers and their environment out of a set of possible network solutions, the set of possible network solutions including at least one hybrid solution employing more than one networking topology type;
presenting one or more of the prioritized set of network solutions for selection by the user; and
in response to the user's selection of a network solution, providing a presentation of a set of network products for constructing a network of the group of computers according to the user-selected network solution.

2. The computer-based method of claim 1 further comprising:
presenting in the sequence of questions a query prompting entry of a custom name for each computer in the group and identifiers of their respective locations in the environment of use;
gathering the input data including the custom names of the computers in the group and identifiers of their respective locations;
dynamically generating a network diagram graphically depicting the user-selected network solution, including depicting each of the computers in the group, their respective locations and the network products; and
identifying each of the computer in the group and their respective locations on the network diagram by their respective custom name and identifiers, respectively.

3. The computer-based method of claim 1 further comprising:
presenting in the sequence of questions a query prompting entry of a custom name for each computer in the group and identifiers of their respective locations in the environment of use;
gathering the input data including the custom names of the computers in the group and identifiers of their respective locations;
dynamically generating setup instructions describing a set of steps to construct the network according to the user-selected network solution; and
identifying each of the computer in the group and their respective locations in the setup instructions by their respective custom name and identifiers, respectively.

4. The computer-based method of claim 1 further comprising:
dynamically generating a shopping list of the network products needed for construction of the network according the user-selected network solution, and not characterized in the user's responses as already part of the computers.

5. The computer-based method of claim 1 wherein evaluating the input data comprises:
heuristically identifying a primary computer out of the group of computers based on the input data characterizing each computer's current internet connection type, operating system, and computer type.

6. The computer-based method of claim 1 wherein the set of possible network solutions comprises wireless, Ethernet, phone-line, and power-line network topologies, as well as hybrid combinations of these network topologies, and wherein evaluating the input data comprises:
heuristically identifying the set of suitable network solutions out of the set of possible network solutions based on at least a layout pattern of the computers in separate locations in the environment, connection media availability at the locations, and computer type.

7. The computer-based method of claim 6 wherein the set of possible network solutions further comprises network topology combinations that incorporate internet connection sharing hosted by a primary computer, and other network topology combinations that include a hardware gateway, and wherein evaluating the input data comprises:
heuristically determining whether a hardware gateway is suitable for the group of computers; and
wherein the heuristically identifying the set of suitable network solutions is further based on the determination whether a hardware gateway is suitable.

8. A computer-based method of assisting a user to design a network for a group of computers, the method comprising:
interactively presenting a sequence of questions to the user relating to characteristics of the group of computers and their environment of use;
gathering input data of the user's responses to the questions, the input data comprising at least locations of the computers in the environment, availability of connection media at the respective locations, and type of the computers being desktop or mobile varieties;
evaluating the input data to determine a prioritized set of network solutions suitable for the group of computers and their environment out of a set of possible network solutions, the evaluating comprising heuristically identifying the set of suitable network solutions out of the set of possible network solutions based on at least a layout of the computers in separate locations in the environment, connection media availability at the locations, and computer type;
presenting one or more of the prioritized set of network solutions for selection by the user; and
in response to the user's selection of a network solution, providing a presentation of a set of network products for constructing a network of the group of computers according to the user-selected network solution.

9. A computer-readable program carrying medium having a software program of an interactive network guide carried thereon for assisting a user to design a network for a group of computers, the software program comprising:
programming code for interactively presenting a sequence of questions to the user relating to characteristics of the group of computers and their environment of use;
programming code for gathering input data of the user's responses to the questions;
programming code for evaluating the input data to determine a prioritized set of network solutions suitable for the group of computers and their environment out of a set of possible network solutions, the set of possible network solutions including at least one hybrid solution employing more than one networking topology type;
programming code for presenting one or more of the prioritized set of network solutions for selection by the user; and
programming code for providing in response to the user's selection of a network solution, a presentation of a set of network products for constructing a network of the group of computers according to the user-selected network solution.

10. The computer-readable program carrying medium of claim 9 further comprising:
programming code for presenting in the sequence of questions a query prompting entry of a custom name for each computer in the group and identifiers of their respective locations in the environment of use;
programming code for gathering the input data including the custom names of the computers in the group and identifiers of their respective locations;
programming code for dynamically generating a network diagram graphically depicting the user-selected network solution, including depicting each of the computers in the group, their respective locations and the network products; and
programming code for identifying each of the computer in the group and their respective locations on the network diagram by their respective custom name and identifiers, respectively.

11. The computer-readable program carrying medium of claim 9 further comprising:
programming code for presenting in the sequence of questions a query prompting entry of a custom name for each computer in the group and identifiers of their respective locations in the environment of use;
programming code for gathering the input data including the custom names of the computers in the group and identifiers of their respective locations;
programming code for dynamically generating setup instructions describing a set of steps to construct the network according to the user-selected network solution; and
programming code for identifying each of the computer in the group and their respective locations in the setup instructions by their respective custom name and identifiers, respectively.

12. The computer-readable program carrying medium of claim 9 further comprising:
programming code for dynamically generating a shopping list of the network products needed for construction of the network according the user-selected network solution, and not characterized in the user's responses as already part of the computers.

13. The computer-readable program carrying medium of claim 9 wherein the programming code for evaluating the input data comprises:
programming code for heuristically identifying a primary computer out of the group of computers based on the input data characterizing each computer's current internet connection type, operating system, and computer type.

14. The computer-readable program carrying medium of claim 9 wherein the set of possible network solutions comprises wireless, Ethernet, phone-line, and power-line network topologies, as well as hybrid combinations of these network topologies, and wherein the programming code for evaluating the input data comprises:
programming code for heuristically identifying the set of suitable network solutions out of the set of possible network solutions based on at least a layout pattern of the computers in separate locations in the environment, connection media availability at the locations, and computer type.

15. The computer-readable program carrying medium of claim 9 wherein the set of possible network solutions further comprises network topology combinations that incorporate internet connection sharing hosted by a primary computer, and other network topology combinations that include a hardware gateway, and wherein the programming code for evaluating the input data comprises:
programming code for heuristically determining whether a hardware gateway is suitable for the group of computers; and
wherein the heuristically identifying the set of suitable network solutions is further based on the determination whether a hardware gateway is suitable.

16. A computer-based interactive network guide system for assisting a user to design a network for a group of computers, the system comprising:
a display device;
a processor for executing programming of an interactive network guide; and
a memory for storing the interactive network guide programming, the programming comprising:
a questions/data collection user interface component for interactively presenting a sequence of questions to the user relating to characteristics of the group of computers and their environment of use on the display device, and collecting input data of the user's responses to the questions, the input data comprising at least locations of the computers in the environment, availability of connection media at the respective locations, and type of the computers being desktop or mobile varieties;
an options generator component for evaluating the input data to determine a prioritized set of network solutions suitable for the group of computers and their environment out of a set of possible network solutions, the evaluating comprising heuristically identifying the set of suitable network solutions out of the set of possible network solutions based on at least a layout of the computers in separate locations in the environment, connection media availability at the locations, and computer type;
an options display/selection component for presenting one or more of the prioritized set of network solutions on the display device for selection by the user, and receiving the user's selection of a network solution from the prioritized set; and
a network solution output generator for providing, in response to the user's selection of a network solution, a presentation of a set of network products for constructing a network of the group of computers according to the user-selected network solution.

17. The computer-based interactive network guide system of claim 16 wherein the network solution output generator comprises a network diagram generator, a shopping list generator and a setup instructions generator for dynamically generating a network diagram, a shopping list of the network products and setup instructions for constructing the network, respectively.

18. The computer-based interactive network guide system of claim 17 wherein:
the questions/data collection user interface component presents in the sequence of questions a query prompting entry of a custom name for each computer in the group and identifiers of their respective locations in the environment of use, and collects the input data including the custom names of the computers in the group and identifiers of their respective locations;
the network diagram generator dynamically generates a network diagram graphically depicting the user-selected network solution, including depicting each of the computers in the group, their respective locations and the network products, including identifying each of the computer in the group and their respective locations on the network diagram by their respective custom name and identifiers, respectively;
the setup instructions generator dynamically generates setup instructions describing a set of steps to construct the network according to the user-selected network solution, including identifying each of the computer in the group and their respective locations in the setup instructions by their respective custom name and identifiers, respectively.

19. The computer-based interactive network guide system of claim 18 wherein the network diagram generator and shopping list generator dynamically generate the network diagram and shopping list, respectively, to include identifiers correlating the depiction of the network products in the network diagram with respective item listings in the shopping list.
